(19) United States
(12) Patent Application Publication
(10) Pub. No.: US 2026/0018142 A1
(43) Pub. Date: Jan. 15, 2026

(54) DISPLAY APPARATUS

(71) Applicant: SAMSUNG ELECTRONICS CO., LTD., Suwon-si (KR)

(72) Inventors: Sungyeol KIM, Suwon-si (KR); Jungmo KANG, Suwon-si (KR); Myungjoon KIM, Suwon-si (KR); Sujin KIM, Suwon-si (KR); Seungyong SHIN, Suwon-si (KR)

(73) Assignee: SAMSUNG ELECTRONICS CO., LTD., Suwon-si (KR)

(21) Appl. No.: 19/253,132

(22) Filed: Jun. 27, 2025

Related U.S. Application Data
(63) Continuation of application No. PCT/KR2025/007819, filed on Jun. 9, 2025.

(30) Foreign Application Priority Data
Jul. 15, 2024 (KR) 10-2024-0092957
Nov. 1, 2024 (KR) 10-2024-0153812

(51) Int. Cl. G09G 3/34

(52) U.S. Cl. CPC G09G 3/3426; G09G 2320/0233; G09G 2320/064; G09G 2320/066; G09G 2330/021; G09G 2354/00

(57) ABSTRACT

A display apparatus including: a liquid crystal panel and a backlight unit. The backlight unit includes a substrate, a plurality of dimming blocks provided in a plurality of rows and a plurality of columns on the substrate, each dimming block of the plurality of dimming blocks including a plurality of light emitting devices, and a plurality of driving devices that drive the plurality of dimming blocks. Each light emitting device of the plurality of light emitting devices includes a red light emitting diode (LED), a green LED, and a blue LED. The display apparatus controls the plurality of driving devices to adjust a current value that is supplied to at least one of the red LED, the green LED, or the blue LED, according to an image mode.

### CROSS-REFERENCE TO RELATED APPLICATIONS

This application is a bypass continuation of International Application No. PCT/KR2025/007819, filed on Jun. 9, 2025, which is based on and claims priority to Korean Patent Application No. 10-2024-0092957, filed on Jul. 15, 2024, in the Korean Intellectual Property Office, and Korean Patent Application No. 10-2024-0153812, filed on Nov. 1, 2024, in the Korean Intellectual Property Office, the disclosures of which are incorporated by reference herein in their entireties.

### BACKGROUND

### 1. Field

The disclosure relates to a display apparatus, and more particularly, to a display apparatus including a liquid crystal panel and a backlight unit (BLU).

### 2. Description of Related Art

A display apparatus converts acquired or stored electrical information into visual information to display the visual information for users. The display apparatus is widely used in various fields, such as home or places of business.

The display apparatus includes a backlight unit (BLU) that provides light to a liquid crystal panel, and the backlight unit includes a plurality of point light emitting devices that can independently emit light. The light emitting devices include, for example, light emitting diodes (LEDs) or organic light emitting diodes (OLEDs).

Local dimming technology used in the backlight unit of an LED TV is a key technology for improving the contrast ratio of the display. A local dimming system divides a display screen into several zones and independently controls current for each zone according to an input image. Accordingly, the local dimming system reduces current when an input image is dark and increases current when an input image is bright, thereby effectively improving the contrast ratio.

### SUMMARY

An aspect of the disclosure provides a display apparatus capable of reducing power consumption by adjusting a current value that is supplied to at least one of a red light emitting diode (LED), a green LED, or a blue LED included in a backlight unit according to an image mode.

The technical object intended to be achieved by the disclosure is not limited to the above-mentioned technical object, and other technical objects not mentioned will be clearly understood by one of ordinary skill in the technical art to which the disclosure belongs from the following description.

According to an aspect of the disclosure, there is provided a display apparatus including: a liquid crystal panel; memory storing instructions; a backlight unit configured to provide light to the liquid crystal panel; and at least one processor configured to control the liquid crystal panel and the backlight unit, wherein the backlight unit includes: a substrate; a plurality of dimming blocks provided in a plurality of rows and a plurality of columns on the substrate, each dimming block of the plurality of dimming blocks including a plurality of light emitting devices; and a plurality of driving devices configured to drive the plurality of dimming blocks, wherein each light emitting device of the plurality of light emitting devices includes a red light emitting diode (LED), a green LED, and a blue LED, and wherein the instructions, when executed by the at least one processor, cause the display apparatus to control the plurality of driving devices to adjust a current value that is supplied to at least one of the red LED, the green LED, or the blue LED, according to an image mode.

The instructions, when executed by the at least one processor, may cause the display apparatus to control the plurality of driving devices to reduce the current value that is supplied to the at least one of the red LED, the green LED, or the blue LED according to the image mode.

The instructions, when executed by the at least one processor, may cause the display apparatus to control the plurality of driving devices to supply current corresponding to the reduced current value to the plurality of dimming blocks based on obtained image information.

The instructions, when executed by the at least one processor, may cause the display apparatus to reduce the current value that is supplied to the green LED and the blue LED through pulse amplitude modulation (PAM) control and supply the current corresponding to the reduced current value to the plurality of dimming blocks.

The instructions, when executed by the at least one processor, may cause the display apparatus to control the plurality of driving devices to supply the current corresponding to the image information to each dimming block of the plurality of dimming blocks based on the image information.

The instructions, when executed by the at least one processor, may cause the display apparatus to supply the current corresponding to the image information to each dimming block of the plurality of dimming blocks through pulse width modulation (PWM) control.

The display apparatus may further include an input device configured to obtain a user input, wherein the instructions, when executed by the at least one processor, may cause the display apparatus to change the image mode based on the user input obtained through the input device.

The instructions, when executed by the at least one processor, may cause the display apparatus to automatically change the image mode based on image information. 9.

The display apparatus of claim 1, wherein each driving device of the plurality of driving devices is configured to supply driving current to the plurality of light emitting devices included in at least two dimming blocks.

The display apparatus may further include: a plurality of current supply lines through which each driving device of the plurality of driving devices supplies driving current, wherein the plurality of current supply lines supply driving current to LEDs having a same color.

The plurality of driving devices may be provided on an upper surface of the substrate or a lower surface of the substrate.

Each dimming block of the plurality of dimming blocks may include a preset number of light emitting devices.

According to an aspect of the disclosure, there is provided a display apparatus including: a liquid crystal panel; memory storing instructions; a backlight unit configured to provide light to the liquid crystal panel; an input device configured to obtain a user input; and at least one processor configured to control the liquid crystal panel and the backlight unit, wherein the backlight unit includes: a substrate; a plurality of dimming blocks provided in a plurality of rows and a plurality of columns on the substrate, each dimming block of the plurality of dimming blocks including a plurality of light emitting devices; and a plurality of driving devices configured to drive the plurality of dimming blocks, wherein each light emitting device of the plurality of light emitting devices includes a red light emitting diode (LED), a green LED, and a blue LED, and wherein the instructions, when executed by the at least one processor, cause the display apparatus to control the plurality of driving devices to reduce a current value that is supplied to at least one of the red LED, the green LED, or the blue LED based on a change of an image mode according to a user's input of selecting another image mode, obtained through the input device.

The instructions, when executed by the at least one processor, may cause the display apparatus to control the plurality of driving devices to supply current corresponding to the reduced current value to the plurality of dimming blocks based on obtained image information.

The instructions, when executed by the at least one processor, may cause the display apparatus to control the plurality of driving devices to supply the current corresponding to the image information to each dimming block of the plurality of dimming blocks based on the image information.

### BRIEF DESCRIPTION OF THE DRAWINGS

The above and other aspects and features of embodiments of the disclosure will be more apparent from the following description taken in conjunction with the accompanying drawings, in which:

FIG. 1 shows an example of an appearance of a display apparatus according to an embodiment;

FIG. 2 shows an example of a structure of a display apparatus according to an embodiment;

FIG. 3 shows an example of a liquid crystal panel included in a display apparatus according to an embodiment;

FIG. 4 shows an example of a backlight unit (BLU) included in a display apparatus according to an embodiment;

FIG. 5 is a view for describing dimming blocks divided from a plurality of light emitting diodes of a backlight unit according to an embodiment;

FIG. 6 is a control block diagram of a display apparatus according to an embodiment;

FIG. 7 shows an example of converting image data into dimming data, performed by a display apparatus according to an embodiment;

FIG. 8 shows an example of a light emitting device included in a backlight unit according to an embodiment;

FIG. 9 is a view for describing an existing image output using single light;

FIG. 10 is a view for describing an image output using a backlight unit that includes light emitting diodes (LEDs) having a plurality of colors according to an embodiment:

FIG. 11 shows adjusting maximum current values according to image modes according to an embodiment;

FIG. 12 is a view for describing 10-bit division in a state where a maximum current value is adjusted according to an embodiment;

FIG. 13 is a view for describing a process of performing existing local dimming;

FIG. 14 is a view for describing a process of performing local dimming according to an embodiment;

FIG. 15 is a view for comparing an operation of performing local dimming according to an embodiment;

FIG. 16 is a flowchart illustrating a local dimming process performed by a display apparatus according to an embodiment;

FIG. 17 is a view for describing selecting an image mode according to an embodiment;

FIG. 18 is a view for describing automatically changing an image mode according to an embodiment;

FIG. 19 is a flowchart illustrating a process of automatically changing an image mode according to an embodiment;

FIGS. 20 and 21 show an arrangement of a dimming driver, a driving device, and a light emitting device, included in a display apparatus according to an embodiment;

FIG. 22 is a view for describing driving current wires of a driving device of a backlight unit according to an embodiment;

FIG. 23 shows a substrate and a bottom chassis of a display apparatus according to an embodiment; and

FIG. 24 is an enlarged view of a portion of a substrate and a bottom chassis of a display apparatus according to an embodiment.

### DETAILED DESCRIPTION

Configurations illustrated in the embodiments and the drawings described in the disclosure are only example embodiments of the disclosure, and thus it is to be understood that various modified examples, which may replace the embodiments and the drawings described in the disclosure, are possible when filing the present application.

Also, like reference numerals or symbols denoted in the drawings of the disclosure represent members or components that perform substantially the same functions.

The terms used in the disclosure are merely used to describe the embodiments, and are not intended to limit and/or restrict the disclosure. An expression used in the singular encompasses the expression of the plural, unless it has a clearly different meaning in the context. In the disclosure, it is to be understood that the terms such as “comprising”, “including” or “having”, etc., are intended to indicate the existence of the features, numbers, steps, operations, components, parts, or combinations thereof disclosed in the disclosure, and are not intended to preclude the possibility that one or more other features, numbers, steps, operations, components, parts, or combinations thereof may exist or may be added.

In this disclosure, it will be understood that when a component is referred to as being “connected” or “coupled” to another component, it can be directly or indirectly connected or coupled to the other component.

Also, it will be understood that, although the terms including ordinal numbers, such as “first”, “second”, etc., may be used herein to describe various components, these components should not be limited by these terms. These terms are only used to distinguish one component from another. For example, a first component could be termed a second component, and, similarly, a second component could be termed a first component, without departing from the scope of the disclosure. As used herein, the term “and/or” includes any and all combinations of one or more of associated listed items.

Hereinafter, an embodiment of the disclosure will be described in detail with reference to the accompanying drawings.

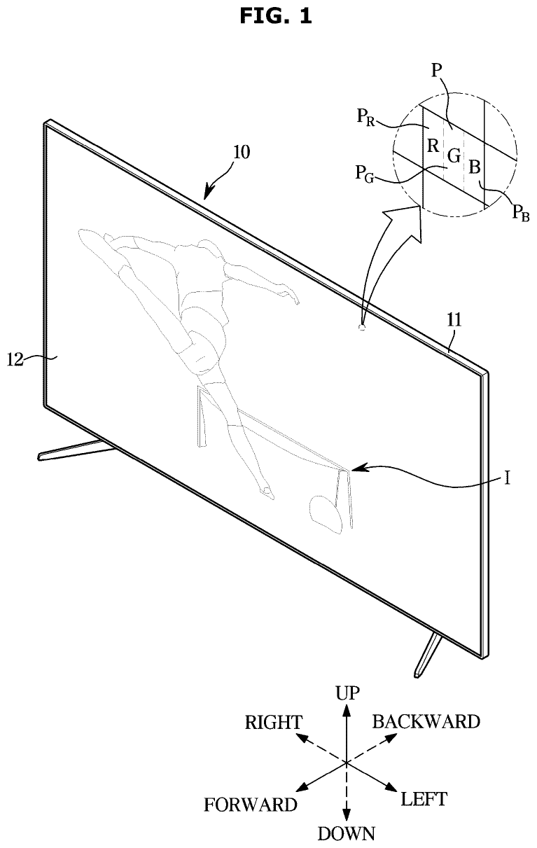

FIG. 1 shows an example of an appearance of a display apparatus according to an embodiment.

Referring to FIG. 1, a display apparatus 10 may process an image signal received from outside to generate an image and visually display the processed image. Hereinafter, the display apparatus 10 is assumed to be a television (TV). However, the display apparatus 10 may be implemented, for example, as one of various apparatuses, such as a monitor, a portable multimedia apparatus, a portable communication apparatus, etc. That is, the display apparatus 10 may be any kind of apparatus that visually displays images.

Also, the display apparatus 10 may be a large format display (LFD) that is installed in an outdoor space, such as the top of building or a bus stop. The outdoor space is not limited to open-air spaces, and the display apparatus 10 according to an embodiment of the disclosure may be installed in any place where many people come in and out, such as a subway station, a shopping mall, a theater, an office, a store, etc., although the place is an indoor space.

The display apparatus 10 may receive content including a video signal and an audio signal from various content sources, and output video and audio corresponding to the video signal and audio signal. For example, the display apparatus 10 may receive content data through a broadcasting reception antenna or a wired cable, receive content data from a content reproducing apparatus, or receive content data from a content providing server of a content provider.

As shown in FIG. 1, the display apparatus 10 may include a main body 11 and a screen 12 that displays an image I.

The main body 11 may form an appearance of the display apparatus 10, and components for enabling the display apparatus 10 to display an image I or perform various functions may be installed inside the main body 11. The main body 11 shown in FIG. 1 may be in a shape of a flat plate, however, the shape of the main body 11 is not limited to that shown in FIG. 1. For example, the main body 11 may be in a shape of a curved plate.

The screen 12 may be formed on a front surface of the main body 11 and display an image I. For example, the screen 12 may display a still image or a moving image. Also, the screen 12 may display a two-dimensional image or a three-dimensional image using a user's binocular disparity.

The screen 12 may include a liquid crystal panel for transmitting or blocking light emitted from a backlight unit (BLU), etc.

In the screen 12, a plurality of pixels P may be formed, and an image I displayed on the screen 12 may be formed by light emitted from the plurality of pixels P. For example, light emitted from the plurality of pixels P may be combined like a mosaic to form an image I on the screen 12.

Each of the plurality of pixels P may emit light having various brightness and various colors. To emit light having various colors, each of the plurality of pixels P may include a plurality of sub pixels PR, PG, and PB.

The sub pixels PR, PG, and PB may include a red sub pixel PR capable of emitting red light, a green sub pixel PG capable of emitting green light, and a blue sub pixel PB capable of emitting blue light. For example, the red light may correspond to light of a wavelength range from about 700 nm (nanometer, one billionth of a meter) to about 800 nm, the green light may correspond to light of a wavelength range from about 500 nm to about 600 nm, and the blue light may correspond to light of a wavelength range from about 400 nm to about 500 nm.

Each of the plurality of pixels P may emit light having various brightness and various colors by a combination of red light from the red sub pixel PR, green light from the green sub pixel PG, and blue light from the blue sub pixel PB.

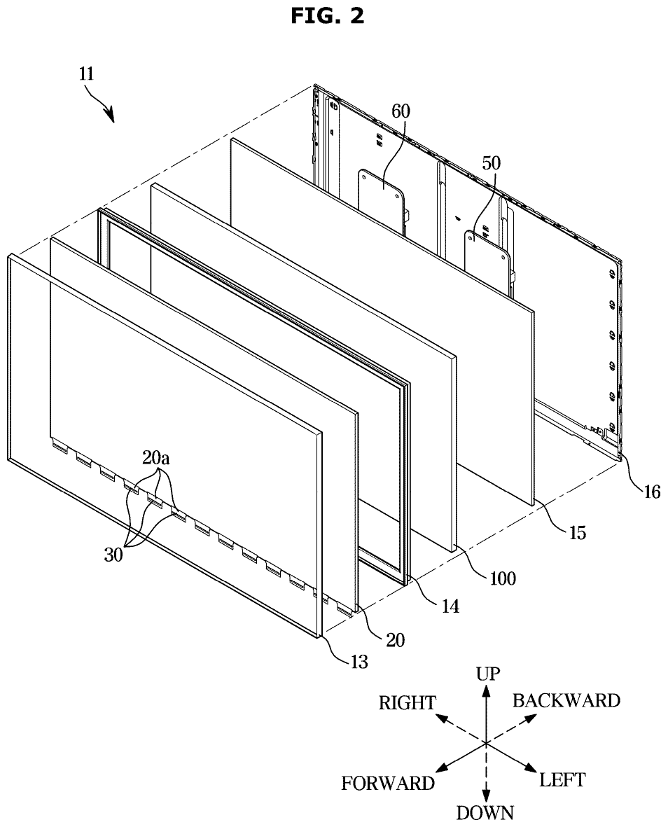

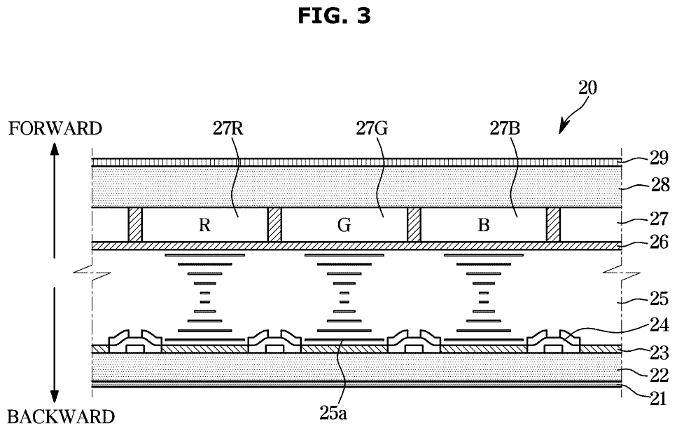

FIG. 2 shows an example of a structure of the display apparatus 10 according to an embodiment, and FIG. 3 shows an example of a liquid crystal panel included in the display apparatus 10 according to an embodiment.

As shown in FIG. 2, various components for displaying an image I on the screen S may be installed inside the main body 11.

For example, a backlight unit 100 being a surface light source, a liquid crystal panel 20 for transmitting or blocking light emitted from the backlight unit 100, a control assembly 50 for controlling operations of the backlight unit 100 and the liquid crystal panel 20, and a power assembly 60 for supplying power to the backlight unit 100 and the liquid crystal panel 20 may be provided in the main body 11. Also, the main body 11 may include a bezel 13, a frame middle mold 14, a bottom chassis 15, and a rear cover 16 for supporting the liquid crystal panel 20, the backlight unit 100, the control assembly 50, and the power assembly 60.

The backlight unit 100 may include a point light source for emitting white light. Also, the backlight unit 100 may refract, reflect, and scatter light emitted from the point light source to convert the light into uniform surface light. As such, the backlight unit 100 may emit uniform surface light toward a front direction by refracting, reflecting, and scattering light emitted from the point light source.

The backlight unit 100 will be described in more detail, below.

The liquid crystal panel 20 may be positioned in front of the backlight unit 100, and block or transmit light emitted from the backlight unit 100 to form an image I.

A front surface of the liquid crystal panel 20 may form the above-described screen S of the display apparatus 10, and the liquid crystal panel 20 may form the plurality of pixels P. Each of the plurality of pixels P of the liquid crystal panel 20 may independently block or transmit light emitted from the backlight unit 100. Also, light transmitted by the plurality of pixels P may form an image I that is displayed on the screen S.

For example, as shown in FIG. 3, the liquid crystal panel 20 may include a first polarizing film 21, a first transparent substrate 22, a pixel electrode 23, a thin film transistor 24, a liquid crystal layer 25, a common electrode 26, a color filter 27, a second transparent substrate 28, and a second polarizing film 29.

The first transparent substrate 22 and the second transparent substrate 28 may fix and support the pixel electrode 23, the thin film transistor 24, the liquid crystal layer 25, the common electrode 26, and the color filter 27. The first and second transparent substrates 22 and 28 may be made of tempered glass or a transparent resin.

The first polarizing film 21 and the second polarizing film 29 may be respectively positioned on outer surfaces of the first and second transparent substrates 22 and 28. The first polarizing film 21 and the second polarizing film 29 may transmit specific polarized light and block (reflect or absorb) the other polarized light. For example, the first polarizing film 21 may transmit polarized light traveling toward a first direction and block (reflect or absorb) the other polarized light. Also, the second polarizing film 29 may transmit polarized light traveling toward a second direction and block (reflect or absorb) the other polarized light, wherein the second direction may be orthogonal to the first direction. Accordingly, polarized light transmitted by the first polarizing film 21 may not be directly transmitted through the second polarizing film 29.

The color filter 27 may be provided on an inner side of the second transparent substrate 28. The color filter 27 may include, for example, a red filter 27R transmitting red light, a green filter 27G transmitting green light, and a blue filter 27B transmitting blue light. Also, the red filter 27R, the green filter 27G, and the blue filter 28B may be arranged side by side. An area occupied by the color filter 27 may correspond to a pixel P described above. An area occupied by the red filter 27R may correspond to a red sub pixel PR, an area occupied by the green filter 27G may correspond to a green sub pixel PG, and an area occupied by the blue filter 27B may correspond to a blue sub pixel PB.

The pixel electrode 23 may be provided on an inner side of the first transparent substrate 22, and the common electrode 26 may be provided on the inner side of the second transparent substrate 28. The pixel electrode 23 and the common electrode 26 may be made of a metal material carrying electricity, and form an electric field for changing an arrangement of liquid crystal molecules 115a configuring the liquid crystal layer 25 which will be described below.

The thin film transistor 24 may be positioned on the inner surface of the first transparent substrate 22. The thin film transistor 24 may be turned on (closed) or turned off (opened) by image data provided from a panel driver 30. Also, according to turning-on (closing) or turning-off (opening) of the thin film transistor 24, an electric field may be formed or removed between the pixel electrode 23 and the common electrode 26.

The liquid crystal layer 25 may be formed between the pixel electrode 23 and the common electrode 26, and the liquid crystal layer 25 may be filled with the liquid crystal molecules 25a. Liquid crystal is in an intermediate state between a solid (crystal) state and a liquid state. The liquid crystal shows an optical property according to a change in electric field. For example, the direction of the molecular arrangement of liquid crystal changes according to a change in electric field. As a result, the optical property of the liquid crystal layer 25 may change according to the presence/absence of an electric field passing through the liquid crystal layer 25. For example, the liquid crystal layer 25 may rotate a polarizing direction of light with respect to an optical axis according to presence/absence of an electric field. Thereby, a polarizing direction of polarized light passed through the first polarizing film 21 may rotate while the polarized light passes through the liquid crystal layer 25, and then the resultant polarized light may pass through the second polarizing film 29.

At one edge of the liquid crystal panel 20, a cable 20a for transmitting image data to the liquid crystal panel 20, and a display driver integrated circuit (DDI) (hereinafter, referred to as a ‘panel driver’) 30 for processing digital image data and outputting an analog image signal may be provided.

The cable 20a may electrically connect the control assembly 50/power assembly 60 to the panel driver 30, and also electrically connect the panel driver 30 to the liquid crystal panel 20. The cable 20a may include a flexible flat cable or a film cable.

The panel driver 30 may receive image data and power from the control assembly 50/power assembly 60 through the cable 20a. Also, the panel driver 30 may provide image data and driving current to the liquid crystal panel 20 through the cable 20a.

Also, the cable 20a and the panel driver 30 may be integrated into one body and implemented as a film cable, a chip on film (COF), a tape carrier package (TCP), etc. In other words, the panel driver 30 may be positioned on the cable 20a, although not limited thereto. However, the panel driver 30 may be positioned on the liquid crystal panel 20.

The control assembly 50 may include a control circuit for controlling operations of the liquid crystal panel 20 and the backlight unit 100. For example, the control circuit may process a video signal and/or an audio signal received from an external content source. The control circuit may transmit image data to the liquid crystal panel 20 and transmit dimming data to the backlight unit 100.

The power assembly 60 may include a power circuit for supplying power to the liquid crystal panel 20 and the backlight unit 100. The power circuit may supply power to the control assembly 50, the backlight unit 100, and the liquid crystal panel 20.

The control assembly 50 and the power assembly 60 may be implemented with a printed circuit board and various kinds of circuits mounted on the printed circuit board. For example, the power circuit may include a capacitor, a coil, a resistor device, a processor, and a power circuit board on which the capacitor, the coil, the resistor device, and the processor are mounted. Also, the control circuit may include a memory, a processor, and a control circuit board on which the memory and the processor are mounted.

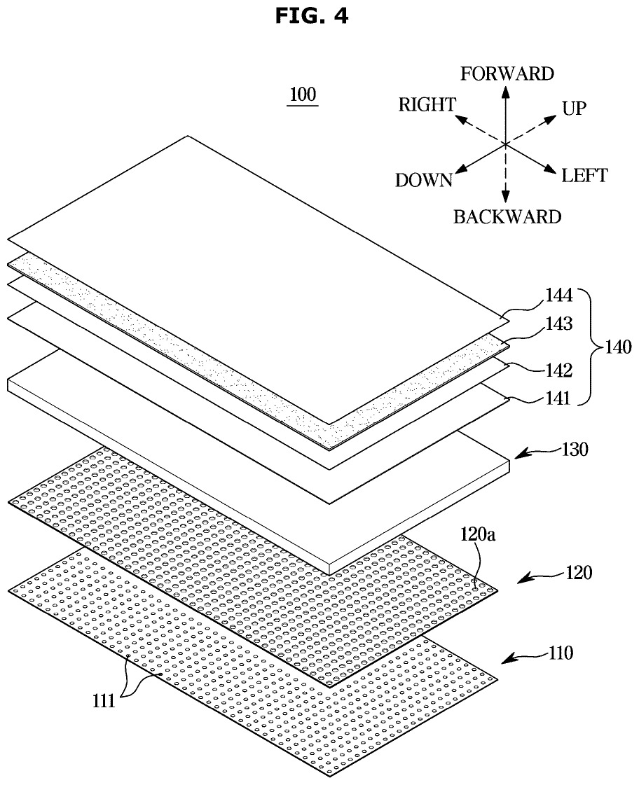

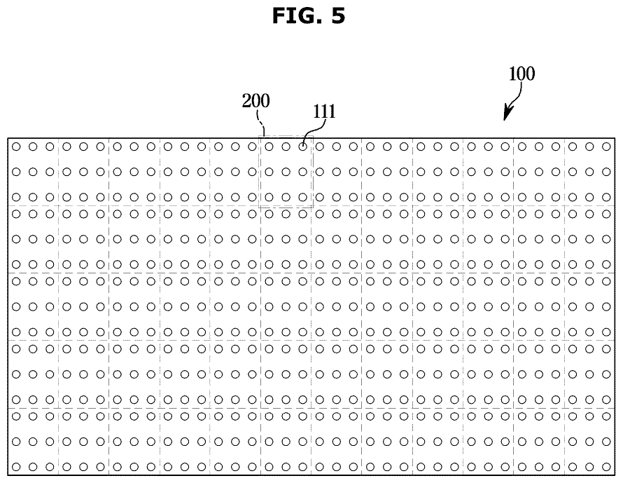

FIG. 4 shows an example of the backlight unit 100 included in the display apparatus 10 according to an embodiment, and FIG. 5 is a view for describing dimming blocks divided from a plurality of light emitting diodes (LEDs) of the backlight unit 100 according to an embodiment.

As shown in FIG. 4, the backlight unit 100 may include a light source module 110 for generating light, a reflective sheet 120 for reflecting light, a diffuser plate 130 for uniformly diffusing light, and an optical sheet 140 for improving brightness of exit light.

The light source module 110 may include a plurality of light emitting devices 111 for emitting light, and a substrate 112 for supporting/fixing the plurality of light emitting devices 111.

The plurality of light emitting devices 111 may be arranged in a preset pattern to emit light with uniform brightness. The plurality of light emitting devices 111 may be arranged such that distances between each light emitting device and the neighboring light emitting devices are the same.

For example, as shown in FIG. 4, the plurality of light emitting devices 111 may be arranged in regular rows and columns. For example, the plurality of light emitting devices 111 may be arranged such that four neighboring light emitting devices form substantially a square. Also, any one light emitting device may be adjacent to four light emitting devices, and distances between the light emitting device and the four adjacent light emitting devices may be substantially the same.

Also, according to some embodiments, the plurality of light emitting devices 111 may be arranged such that three neighboring light emitting devices form substantially an equilateral triangle. In this case, one light emitting device may be adjacent to six light emitting devices, and, also, distances between the light emitting device and the six adjacent light emitting devices may be substantially the same.

However, an arrangement of the plurality of light emitting devices 111 is not limited to the above-described arrangement, and the plurality of light emitting devices 111 may be arranged in various ways to emit light with uniform brightness.

Each light emitting device 111 may adopt a device capable of emitting, upon receiving power, monochromatic light (light having a specific wavelength, for example, blue light) or white light (for example, mixed light of red light, green light, and blue light) in various directions. For example, the light emitting device 111 may include an LED. The LED may have various sizes, and for example, the LED may include a mini LED and/or a micro LED.

The substrate 112 may fix the plurality of light emitting devices 111 to prevent the light emitting devices 111 from moving. Also, the substrate 112 may supply power for enabling the light emitting devices 111 to emit light to the individual light emitting devices 111.

The substrate 112 may include a synthetic resin and/or tempered glass and/or a printed circuit board (PCB), on which a conductive power supply line for fixing the plurality of light emitting devices 111 and supplying power to the light emitting devices 111 is formed.

Also, the substrate 112 may include a plurality of sub substrates 112′.

The reflective sheet 120 may reflect light emitted from the plurality of light emitting devices 111 toward the front direction or toward an approximately front direction.

In the reflective sheet 120, a plurality of through holes 120a may be formed at locations respectively corresponding to the plurality of light emitting devices 111 of the light source module 110. Also, the light emitting devices 111 of the light source module 110 may pass through the through holes 120a, and protrude forward from the reflective sheet 120.

For example, during an assembly process of the reflective sheet 120 and the light source module 110, the plurality of light emitting devices 111 of the light source module 110 may be inserted into the plurality of through holes 120a formed in the reflective sheet 120. Therefore, although the substrate 112 of the light source module 110 is located behind the reflective sheet 120, the plurality of light emitting devices 111 of the light source module 110 may be located in front of the reflective sheet 120.

Accordingly, the plurality of light emitting devices 111 may emit light in front of the reflective sheet 120.

The plurality of light emitting devices 111 may emit light in various directions in front of the reflective sheet 120. Light may be emitted toward the diffuser plate 130 from the light emitting devices 111 and toward the reflective sheet 120 from the light emitting devices 111. The reflective sheet 120 may reflect light emitted toward the reflective sheet 120 toward the diffuser plate 130.

Light emitted from the light emitting devices 111 may pass through various objects, such as the diffuser plate 130, the optical sheet 140, etc. While light passes through the diffuser plate 130 and the optical sheet 140, a part of the light may be reflected from surfaces of the diffuser plate 130 and the optical sheet 140. The reflective sheet 120 may reflect light reflected by the diffuser plate 130 and the optical sheet 140.

The diffuser plate 130 may be provided in front of the light source module 110 and the reflective sheet 120 and may uniformly disperse light emitted from the light emitting devices 111 of the light source module 110.

The plurality of light emitting devices 111 may be positioned at a plurality of locations in a rear portion of the backlight unit 100, as described above. Although the plurality of light emitting devices 111 are arranged at equidistant intervals in the rear portion of the backlight unit 100, brightness non-uniformity may occur according to the locations of the plurality of light emitting devices 111.

The diffuser plate 130 may diffuse light emitted from the plurality of light emitting devices 111 in the inside to remove brightness non-uniformity caused by the plurality of light emitting devices 111. In other words, the diffuser plate 130 may uniformly emit non-uniform light emitted from the plurality of light emitting device 111 through the front surface.

The optical sheet 140 may include various sheets for improving brightness and uniformity of brightness. For example, the optical sheet 140 may include a diffuser sheet 141, a first prism sheet 142, a second prism sheet 143, and a reflective polarizing sheet 144.

The diffuser sheet 141 may diffuse light for brightness uniformity. Light emitted from the light emitting devices 111 may be diffused by the diffuser plate 130 and then again diffused by the diffuser sheet 141 included in the optical sheet 140.

The first and second prism sheets 142 and 143 may concentrate the light diffused by the diffusing sheet 141 to increase brightness. The first and second prism sheets 142 and 143 may include a prism pattern being in a shape of a trigonal prism, and a plurality of prism patterns may be arranged adjacent to each other, thereby forming a plurality of bands.

The reflective polarizing sheet 144 may be a kind of a polarizing film to transmit a part of incident light and reflect the other part of the incident light to improve brightness. For example, the reflective polarizing sheet 144 may transmit polarized light traveling in a preset polarization direction of the reflective polarizing sheet 144 and reflect polarized light traveling in a polarization direction that is different from the preset polarization direction of the reflective polarizing sheet 144. Also, light reflected by the reflective polarizing sheet 144 may be recycled inside the backlight unit 100, and brightness of the display apparatus 10 may be improved by such light recycle.

The optical sheet 140 is not limited to the sheets or films shown in FIG. 4, and may include various sheets or films, such as a protection sheet, etc.

The backlight unit 100 may include the plurality of light emitting devices 111, and diffuse light emitted from the plurality of light emitting devices 111 to output surface light. The liquid crystal panel 20 may include a plurality of pixels, and control each of the plurality of pixels to transmit or block light. An image may be formed by light that has passed through each of the plurality of pixels.

The display apparatus 10 may perform local dimming to vary brightness of light for each area of the backlight unit 100 in conjunction with an output image to improve power consumption while increasing a contrast ratio.

For example, the display apparatus 10 may decrease brightness of light emitted from light emitting devices 111 of the backlight unit 100 corresponding to a dark area of an image to make the dark area darker, and to make a bright area of the image brighter, the display apparatus 10 may increase brightness of light emitted from light emitting devices 111 of the backlight unit 100 corresponding to the bright area of the image. Therefore, a contrast ratio or brightness ratio of the image may be improved.

The display apparatus 10 may divide the backlight unit 100 into a plurality of blocks and adjust current independently for each block according to an input image. Image transmission of the display apparatus 10 may be performed through frame-based local dimming driving, and driving of current may be controlled according to the number of blocks of the light emitting devices 111 in the backlight unit 100.

As a result, the display apparatus 10 may supply less current to dimming blocks corresponding to a dark area of an input image and supply more current to dimming blocks corresponding to a bright area of the image, thereby effectively improving a contrast ratio.

For local dimming, the plurality of light emitting devices 111 included in the backlight unit 100 may be divided into a plurality of dimming blocks 2000. For example, the plurality of dimming blocks 200 may be configured in a total of 60, configured with 5 rows and 12 columns, as shown in FIG. 5. As another example, the plurality of dimming blocks 200 may be configured in a total of 20, configured with 5 rows and 4 columns. However, the number of the dimming blocks 200 is not limited to these examples.

Referring to FIG. 5, each dimming block of the plurality of dimming blocks 200 may include one or more light emitting devices 111. The backlight unit 100 may supply the same driving current to the light emitting devices 111 belonging to the same dimming block 200, and the light emitting devices 111 belonging to the same dimming block 200 may emit light having the same brightness.

Also, the backlight unit 100 may supply different driving current to light emitting devices 111 belonging to different dimming blocks 200 according to dimming data, and the light emitting devices 111 belonging to the different dimming blocks 200 may emit light having different brightness.

Each of the plurality of dimming blocks 200 may include N*M light sources arranged in a N*M matrix form (N and M are natural numbers). The N*M matrix may be a matrix having N rows and M columns.

Because each of the light emitting devices 111 includes an LED, each of the plurality of dimming blocks 200 may include N*M LEDs. That is, each of the plurality of dimming blocks 200 may include a preset number of light emitting devices 111.

The plurality of dimming blocks 200 may be positioned on the substrate 112. That is, the N*M LEDs may be positioned on the substrate 112. Alternatively, the plurality of dimming blocks 200 may be positioned on the plurality of sub substrates 112′ included in the substrate 112.

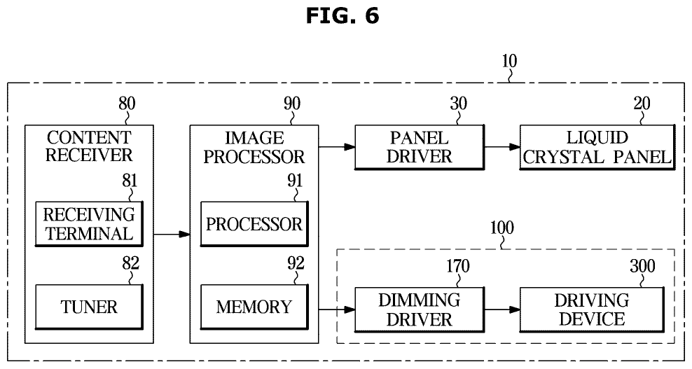

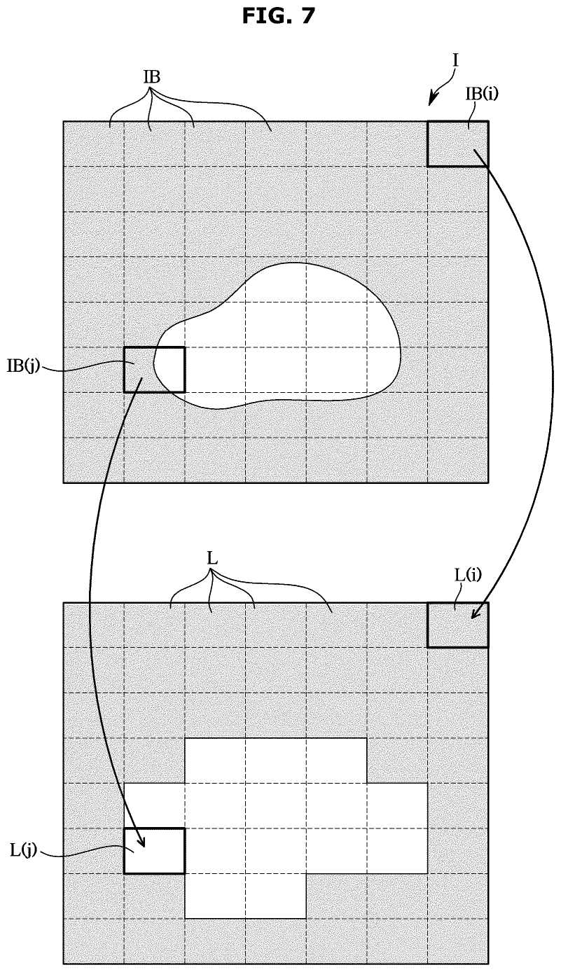

FIG. 6 is a control block diagram of a display apparatus according to an embodiment, and FIG. 7 shows an example of converting image data into dimming data, performed by a display apparatus according to an embodiment.

Referring to FIG. 6, the display apparatus 10 may include a content receiver 80, an image processor 90, the panel driver 30, the liquid crystal panel 20, and the backlight unit 100. In this case, the backlight unit 100 may include a dimming driver 170 that performs local dimming, and a driving device 300 that drives the light emitting devices 111. The driving device 300 may be positioned on an upper or lower surface of the substrate 112.

The content receiver 80 may include a receiving terminal 81 for receiving a video signal and/or an audio signal from content sources, and a tuner 82.

The receiving terminal 81 may receive a video signal and an audio signal from the content sources through a cable. For example, the receiving terminal 81 may include a component (YPbPr/RGB) terminal, a composite video blanking and sync (CVBS) terminal, an audio terminal, a High Definition Multimedia Interface (HDMI) terminal, an Universal Serial Bus (USB) terminal, etc.

The tuner 82 may receive broadcasting signals from a broadcasting reception antenna or a wired cable and extract a broadcasting signal of a channel selected by a user from among the broadcasting signals. For example, the tuner 82 may pass a broadcasting signal having a frequency corresponding to a channel selected by a user among a plurality of broadcasting signals received through the broadcasting reception antenna or the wired cable, and block broadcasting signals having the other frequencies.

As such, the content receiver 80 may receive an image including a video signal and an audio signal from the content sources through the receiving terminal 81 and/or the tuner 82, and output the image received through the receiving terminal 81 and/or the tuner 82 to the image processor 90.

The image processor 90 may include at least one processor 91 that processes an input image (image data) and memory 92 that memories/stores data.

The memory 92 may store a program (instructions) and data for processing a video signal and/or an audio signal, and temporarily memorize data generated while processing the video signal and/or the audio signal.

The memory 92 may include a non-volatile memory, such as Read Only Memory (ROM) and a flash memory, and a volatile memory, such as Static Random Access Memory (S-RAM) and Dynamic Random Access Memory (D-RAM).

The at least one processor 91 may receive an input image including a video signal and/or an audio signal from the content receiver 80, decode the video signal to generate image data, and generate dimming data from the image data. The image data and the dimming data may be output to the panel driver 30 and the dimming driver 170.

The at least one processor 91 may provide dimming data for local dimming to the backlight unit 100. The dimming data may include information about brightness of each of the plurality of dimming blocks 200. For example, the dimming data may include information about an intensity of light output from the light emitting devices 111 included in each of the plurality of dimming blocks 200. That is, the dimming data may include information about a magnitude of current that is supplied to the light emitting devices 111 included in each of the plurality of dimming blocks 200.

The at least one processor 91 may obtain the dimming data from the image data decoded from the video signal.

The processor 91 may convert image data into dimming data by various methods. For example, as shown in FIG. 7, the processor 91 may divide an image I formed by image data into a plurality of image blocks IB. The number of the plurality of image blocks IB may be equal to the number of the plurality of dimming blocks 200, and the plurality of image blocks IB may respectively correspond to the plurality of dimming blocks 200.

The processor 91 may obtain brightness values L of the plurality of dimming blocks 200 from image data of the plurality of image blocks IB. Also, the processor 91 may generate dimming data by combining the brightness values L of the plurality of dimming blocks 200.

For example, the processor 91 may obtain a brightness value L of each of the plurality of dimming blocks 200 based on a maximum value of brightness values of pixels included in each of the image blocks IB.

An image block may include a plurality of pixels, and image data of the image block may include image data (for example, red data, green data, blue data, etc.) of the plurality of pixels. The processor 91 may calculate a brightness value of each pixel based on image data of the pixel.

The processor 91 may set a maximum value of brightness values of pixels included in an image block to a brightness value of a dimming block corresponding to the image block. For example, the processor 91 may set a maximum value of brightness values of pixels included in an i-th image block IB(i) to a brightness value L(i) of an i-th dimming block, and set a maximum value of brightness values of pixels included in a j-th image block IB(j) to a brightness value L(j) of a j-th dimming block.

The processor 91 may generate dimming data by combing brightness values of the plurality of dimming blocks 200.

As such, the image processor 90 may decode a video signal obtained by the content receiver 80 to generate image data and generate dimming data from the image data. Also, the image processor 90 may transmit the image data and the dimming data to the liquid crystal panel 20 and the backlight unit 100, respectively.

The liquid crystal panel 20 may include a plurality of pixels capable of transmitting or blocking light, and the plurality of pixels may be arranged in a matrix form. In other words, the plurality of pixels may be arranged in a plurality of rows and a plurality of columns.

The panel driver 30 may receive image data from the image processor 90 and drive the liquid crystal panel 20 according to the image data. In other words, the panel driver 30 may convert image data (hereinafter, referred to as ‘digital image data’) which is a digital signal into an analog image signal which is an analog voltage signal, and provide the converted analog image signal to the liquid crystal panel 20. Optical properties (for example, light transmittance) of the plurality of pixels included in the liquid crystal panel 20 may change according to the analog image signal.

The panel driver 30 may include, for example, a timing controller, a data driver, a scan driver, etc.

The timing controller may receive image data from the image processor 90 and output the image data and a driving control signal to the data driver and the scan driver. The driving control signal may include a scan control signal and a data control signal, and the scan control signal and the data control signal may be used to respectively control an operation of the scan driver and an operation of the data driver.

The scan driver may receive a scan control signal from the timing controller and input-activate any one of the plurality of rows in the liquid crystal panel 20 according to the scan control signal. In other words, the scan driver may convert pixels included in any row among the plurality of pixels arranged in the plurality of rows and the plurality of columns to a state capable of receiving an analog image signal. At this time, the other pixels input-deactivated, except for the pixels input-activated by the scan driver, may not receive an analog image signal.

The data driver may receive image data and a data control signal from the timing controller and output the image data to the liquid crystal panel 20 according to the data control signal. For example, the data driver may receive digital image data from the timing controller and convert the digital image data into an analog image signal. Also, the data driver may provide the analog image signal to pixels included in any row input-activated by the scan driver. At this time, the pixels input-activated by the scan driver may receive the analog image signal and optical properties (for example, light transmittance) of the input-activated pixels may change according to the received analog image signal.

As such, the panel driver 30 may drive the liquid crystal panel 20 according to the image data. Therefore, an image corresponding to the image data may be displayed on the liquid crystal panel 20.

The backlight unit 100 may include the plurality of light emitting devices 111 that emit light, and the plurality of light emitting devices 111 may be arranged in a matrix form. In other words, the plurality of light emitting devices 111 may be arranged in a plurality of rows and a plurality of columns. Also, the light emitting devices 111 may be divided into a plurality of dimming blocks 200, and each of the plurality of dimming blocks 200 may include at least one light emitting device 111.

The dimming driver 170 may receive dimming data from the image processor 90 and drive the backlight unit 100 according to the dimming data. The dimming data may include information about brightness of each of the plurality of dimming blocks 200 or information about brightness of light emitting devices 111 included in each of the plurality of dimming blocks 200.

The dimming driver 170 may convert dimming data (hereinafter, referred to as ‘digital dimming data’) which is a digital signal, into an analog dimming signal which is an analog voltage signal, and provide the analog dimming signal to the backlight unit 100. An intensity of light emitted from the light emitting devices 111 included in each of the plurality of dimming blocks 200 may change according to the analog dimming signal.

The dimming driver 170 may provide the analog dimming signal sequentially to the plurality of dimming blocks 200 by an active matrix method, instead of directly providing the analog dimming signal to all of the plurality of dimming blocks 200.

As described above, the plurality of dimming blocks 200 may be arranged in a matrix form in the backlight unit 100. In other words, the plurality of dimming blocks 200 may be arranged in a plurality of rows and a plurality of columns in the backlight unit 100.

The dimming driver 170 may provide the analog dimming signal sequentially to dimming blocks belonging to the plurality of rows or to dimming blocks belonging to the plurality of columns.

For example, the dimming driver 170 may input-activate dimming blocks belonging to any row of the plurality of dimming blocks 200 and provide the analog dimming signal to the input-activated dimming blocks. Then, the dimming driver 170 may input-activate dimming block belonging to another row of the plurality of dimming blocks 200 and provide the analog dimming signal to the input-activated dimming blocks.

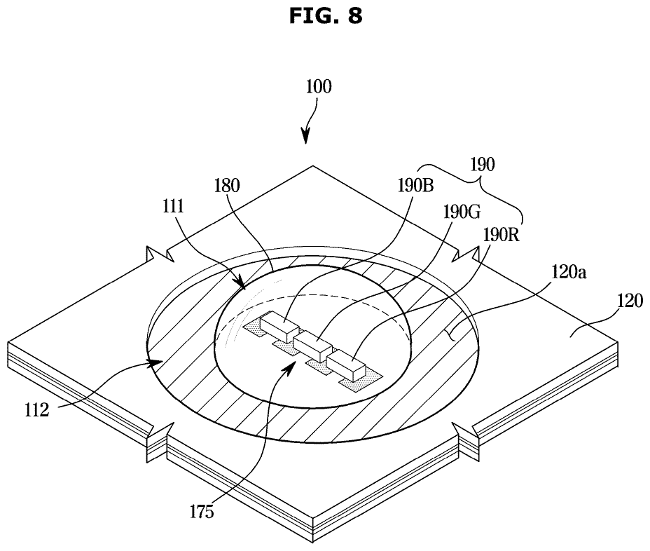

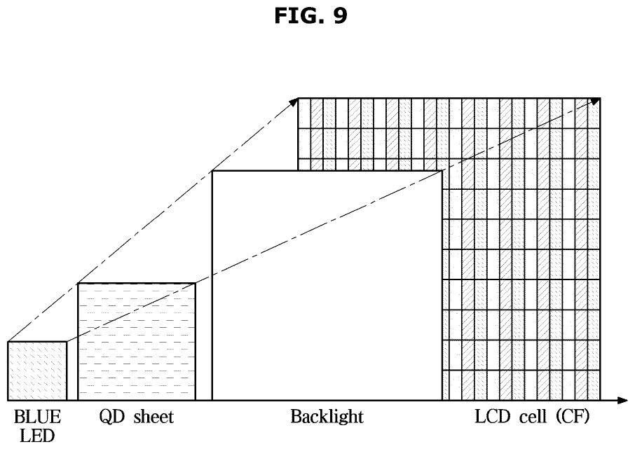

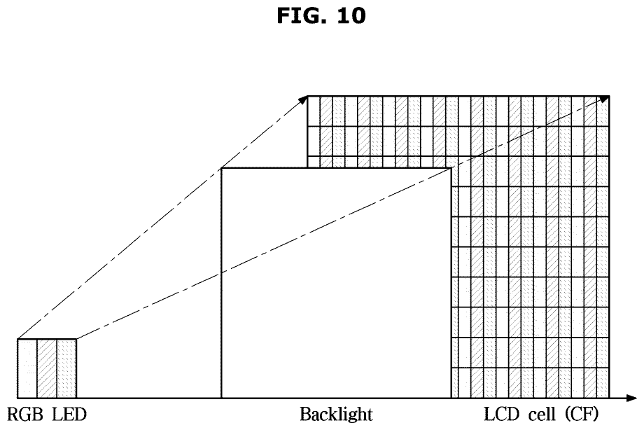

FIG. 8 shows an example of a light emitting device included in a backlight unit according to an embodiment, FIG. 9 is a view for describing an existing image output using single light, and FIG. 10 is a view for describing an image output using a backlight unit that includes LEDs having a plurality of colors according to an embodiment.

Each light emitting device 111 may include an LED group 175. That is, each light emitting device 111 may include a red LED 190R, a green LED 190G, and a blue LED 190B, as shown in FIG. 8.

A plurality of LED groups 170 may be arranged in a two-dimensional matrix form on the upper surface of the substrate 112. That is, as shown in FIG. 4, because the plurality of light emitting devices 111 are arranged in rows and columns, the plurality of LED groups 170 may be arranged in a two-dimensional matrix form.

Also, according to some embodiments, the plurality of light emitting devices 111 may be arranged such that three neighboring light emitting devices form substantially an equilateral triangle. In this case, one light emitting device may be adjacent to six light emitting devices. Also, distances between the light emitting device and the six adjacent light emitting devices may be substantially the same.

However, an arrangement of the plurality of light emitting devices 111 is not limited to the above-described arrangement, and the plurality of light emitting devices 111 may be arranged in various ways to emit light with uniform brightness.

Each light emitting device 111 may adopt a device capable of emitting, upon receiving power, white light (light having a plurality of peak wavelengths, for example, mixed light of red light, green light, and blue light) in various directions.

That is, each light emitting device 111 may emit white light by including a red LED 190R, a green LED 190G, and a blue LED 190B.

As shown in FIG. 8, each light emitting device of the plurality of light emitting devices 111 may include an LED group 175 and an optical dome 180.

The backlight unit 100 may have a small thickness such that the display apparatus 10 has a small thickness. To reduce the thickness of the backlight unit 100, each of the plurality of light emitting devices 111 may have a small thickness and a simple structure.

Each LED included in each LED group 175 may include a P-type semiconductor and an N-type semiconductor to emit light by recombination of holes and electrons. Also, the LED may include a pair of electrodes for supplying holes and electrons to the P-type semiconductor and the N-type semiconductor.

Each of the LEDs 190 (190R, 190G, 190B) may be configured to convert electricity energy into optical energy. Each of the LEDs 190 (190R, 190G, 190B) may emit light having a maximum strength in a preset wavelength based on supplied power. For example, the blue LED 190B may emit blue light having a peak value in a wavelength (for example, a wavelength ranging from 430 nm to 495 nm) that displays a blue color.

For example, a multilayer reflective structure in which a plurality of insulating films having different refractive indices are alternately laminated may be provided on a front surface of each of the LEDs 190 (190R, 190G, 190B). For example, the multilayer reflective structure may be configured as a distributed Bragg reflector (DBR). The DBR is a structure in which two or more materials having different refractive indices are alternately laminated and may be an optical device that has high reflectivity for light of a specific wavelength according to a principle of forming an optical path difference according to a wavelength to induce strong reflection in a specific frequency band.

Also, the LEDs 190 (190R, 190G, 190B) of the LED group 175 may be attached directly to the substrate 112 by a chip on board (COB) method. For example, the light emitting device 111 may include an LED 190 formed by attaching an LED chip or an LED die directly to the substrate 112 without separate packaging.

The LED 190 may be manufactured in a flip chip type. The LED 190 of the flip chip type may be formed by welding, upon attaching an LED being a semiconductor device to the substrate 112, an electrode pattern of a semiconductor device as it is to the substrate 112 without using a middle medium, such as a metal lead (wire) or a ball grid array (BGA). As such, by using neither a metal lead (wire) nor a ball grid array, the light emitting device 111 including the LED 190 of the flip chip type may be miniaturized.

So far, the LED 190 of the flip chip type welded directly to the substrate 112 by the chip on board method has been described. However, the light emitting device 111 is not limited to an LED of a flip chip type. For example, the light emitting device 111 may include an LED of a package type.

The optical dome 180 may cover the LED group 175. That is, the optical dome 180 may cover the red LED 190R, the green LED 190G, and the blue LED 190B, included in the LED group 175.

The optical dome 180 may refract red light, green light, and blue light respectively emitted from the red LED 190R, the green LED 190G, and the blue LED 190B to mix the red light, green light, and blue light, thereby emitting white light.

As such, the optical dome 180 may emit white light by mixing red light, green light, and blue light, and reduce a distance required for mixing to white light, compared to a case in which no optical dome 180 exists, thereby reducing an optical distance OD required for changing point light sources to a surface light source.

Also, the optical dome 180 may prevent or suppress the LEDs 190 from being damaged by a mechanical action from outside and/or by a chemical action.

The optical dome 180 may be in a shape of a dome resulting from cutting, for example, a sphere with a plane not including a center of the sphere, or in a shape of a hemisphere resulting from cutting a sphere with a plane including a center of the sphere. A vertical section of the optical dome 180 may be in a shape of, for example, a segment of a circle or a semicircle.

The optical dome 180 may be formed of silicon or an epoxy resin. For example, the optical dome 180 may be formed by discharging molten silicon or a molten epoxy resin onto the LEDs 190 through a nozzle, etc. and then hardening the silicon or epoxy resin.

The optical dome 180 may be optically transparent or translucent. Light emitted from the LED 190 may pass through the optical dome 180 and be emitted to the outside.

At this time, the optical dome 180 being in a shape of a dome may refract the light, like a lens. For example, light emitted from the LEDs 190 may be refracted by the optical dome 180 and dispersed.

As such, the optical dome 180 may protect the LEDs 190 from an external mechanical and/or chemical action or an electrical action, and disperse light emitted from the LEDs 190.

So far, the optical dome 180 being in a shape of a silicon dome has been described. However, the light emitting device 111 is not limited to including the optical dome 180. For example, the light emitting device 111 may include a lens for dispersing light emitted from the LEDs 190.

As such, because each light emitting device 111 includes the red LED 190R, the green LED 190G, and the blue LED 190B, the disclosure may achieve higher color purity, a higher contrast ratio, and higher image quality in a local dimming operation which will be described below, than in local dimming using single light.

That is, by using a backlight unit including red LEDs 190R, green LEDs 190G, and blue LEDs 190B, as shown in FIG. 10, higher color purity, a higher contrast ratio, and higher image quality may be achieved than in a display including a backlight unit including only blue LEDs and a Quantum Dot (QD) sheet, as shown in FIG. 9. In this case, a QD sheet may not be included as a component of the display apparatus 10.

Hereinafter, a local dimming operation of the backlight unit 100 including the light emitting device 111 including the red LED 190R, the green LED 190G, and the blue LED 190B will be described in detail.

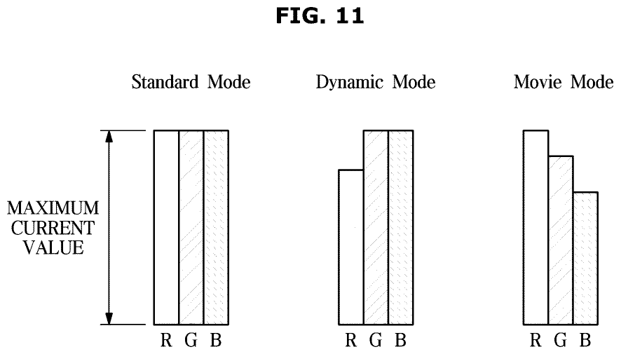

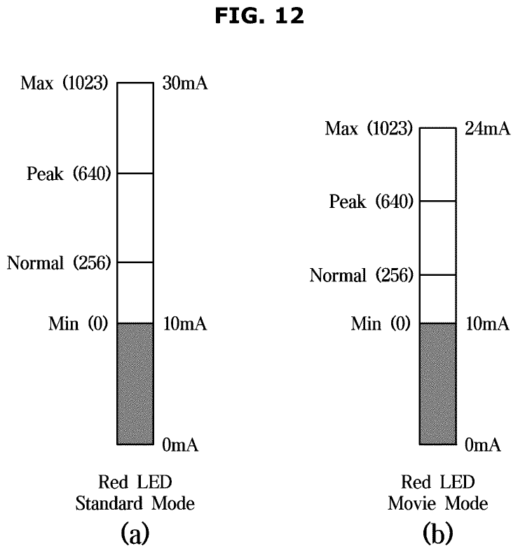

FIG. 11 shows adjusting maximum current values according to image modes according to an embodiment, and FIG. 12 is a view for describing 10-bit division in a state where a maximum current value is adjusted according to an embodiment.

The at least one processor 91 may control, according to a change of an image mode, a plurality of driving devices to adjust current values that are supplied to the red LED 190R, the green LED 190G, and the blue LED 190B.

That is, the at least one processor 91 may control, according to a change of an image mode, the plurality of driving devices to reduce current values that are supplied to the red LED 190R, the green LED 190G, and the blue LED 190B. This may include reducing maximum current values that are supplied to the red LED 190R, the green LED 190G, and the blue LED 190B.

Image modes may increase immersion into an image by controlling gray scales of RGB colors depending on a type of the image. For example, the image modes may include a standard mode, a dynamic mode, and a movie mode. The image modes are not limited thereto and may include more various modes.

The standard mode may be a normal viewing mode, the dynamic mode may be a mode that is suitable to watch dynamic images such as sports, and the movie mode may be a mode that is suitable to watch movies.

The at least one processor 91 may reduce a current value of the red LED 190R according to a change of an image mode to the dynamic mode. Accordingly, light amounts of the green LED 190G and the blue LED 190B may relatively increase to express an image with appropriate colors for viewing dynamic images such as sports.

The at least one processor 91 may reduce, according to a change of an image mode to the movie mode, current values of the green LED 190G and the blue LED 190B. Accordingly, a light amount of the red LED 190R may relatively increase to express an image with appropriate colors for viewing images such as movies.

As such, by reducing current values that are supplied to the light emitting devices 111 of the backlight unit 100, power consumption may be reduced.

Control of reducing current values that are supplied to light emitting devices may be performed through pulse amplitude modulation (PAM) control. The PAM control may be to control brightness of light from light emitting devices by outputting current having different intensities according to image data. The PAM control may be performed through global dimming control to reduce current values that are supplied to all the light emitting devices 111 of the plurality of dimming blocks 200 included in the backlight unit 100.

After the at least one processor 91 reduces current values that are supplied to the light emitting devices 111, the at least one processor 91 may perform 10-bit division on the reduced current values.

That is, for example, in the dynamic mode, the at least one processor 91 may reduce a maximum current value of 30 mA of the red LED 190R, as shown in (a) of FIG. 12, to 24 mA as shown in (b) of FIG. 12.

In this case, to prevent image quality deterioration, the at least processor 91 may perform 10-bit division on the current value of the red LED 190R reduced to 24 mA, like an existing technique. Accordingly, although a current value that is supplied to an LED is reduced according to a change of an image mode, image quality may be maintained.

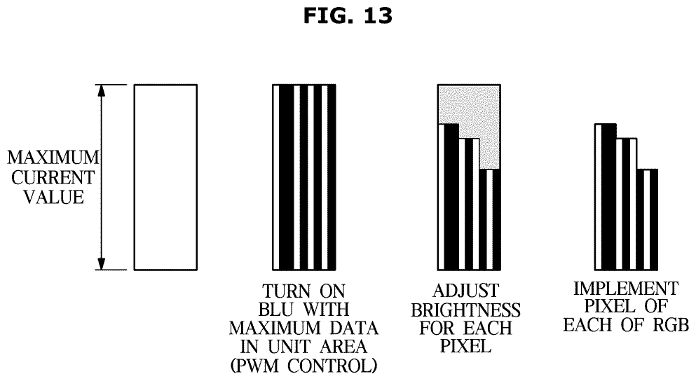

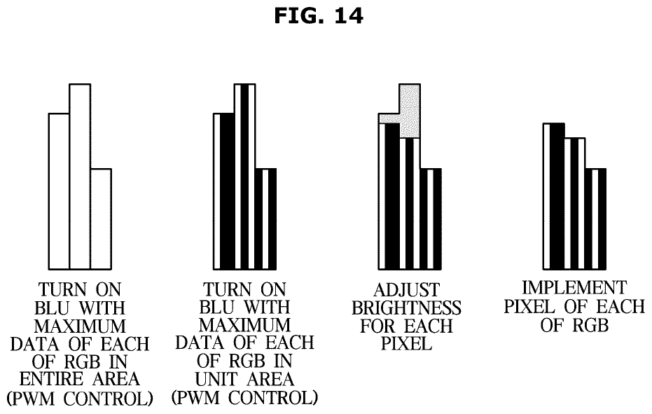

FIG. 13 is a view for describing a process of performing existing local dimming, and FIG. 14 is a view for describing a process of performing local dimming according to an embodiment.

As described above, in the disclosure, by reducing a current value that is supplied to an LED having a specific color in a process of emitting light in the backlight unit 100 in a specific image mode, power consumption may be reduced.

Referring to FIG. 13, an existing technique has adjusted brightness by turning on the light emitting devices 111 with a light amount of maximum brightness in the backlight unit 100 and then performing pulse width modulation (PWM) control or adjusting brightness for each pixel in the liquid crystal panel 20. The PWM control is a method of controlling brightness of light from light emitting devices by changing times at which current is applied to the light emitting devices by controlling on times of switches according to image data.

The disclosure may reduce a current value that is supplied to at least one of the red LED 190R, the green LED 190G, or the blue LED 190B based on a change of an image mode and then adjust brightness through PWM control, brightness control in the liquid crystal panel, etc., similarly to the existing technique, as shown in FIG. 14.

As such, by reducing a current value that is supplied to at least one of the red LED 190R, the green LED 190G, or the blue LED 190B depending on an image mode, power consumption may be reduced, and through more detailed control, higher color purity, a higher contrast ratio, and higher image quality may be implemented.

After the at least one processor 91 performs control of reducing a current value, the at least one processor 91 may control a plurality of driving devices 300 to supply current corresponding to the reduced current value to all of the plurality of dimming blocks 200 based on image information. The control may also be performed through the PAM control.

Thereafter, the at least one processor 91 may control the driving devices 300 to supply current corresponding to the image information to each of the plurality of dimming blocks 200 based on the image information. This may be performed through the PWM control described above.

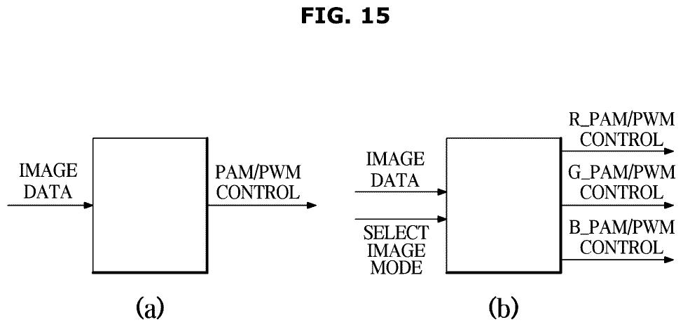

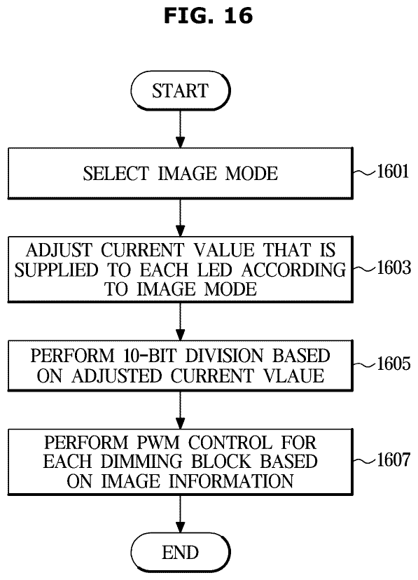

FIG. 15 is a view for comparing an operation of performing local dimming according to an embodiment, and FIG. 16 is a flowchart illustrating a local dimming process performed by a display apparatus according to an embodiment.

The display apparatus 10 may include an input device that receives a user input. According to a selection of an image mode by a user's selection input received through the input device (1601), the at least one processor 91 may adjust a current value that is supplied to each LED having a preset color according to the image mode (1603).

Thereafter, the at least one processor 91 may perform 10-bit division based on the adjusted current value (1605) and then perform PWM control on each of the plurality of dimming blocks 200 based on image information to adjust brightness (1607).

As shown in (a) of FIG. 15, according to the existing technique, light has been emitted from a backlight unit 100 having single light, and PAM control and PWM control have been performed based on received image data to adjust brightness.

According to the disclosure, as shown in (b) of FIG. 15, PAM control of reducing a current value that is supplied to at least one of the red LED 190R, the green LED 190G, or the blue LED 190B in consideration of image data and an input of selecting an image mode may be performed, and then, PWM control may be performed on each LED to adjust brightness.

Hereinafter, a case of changing an image mode will be described.

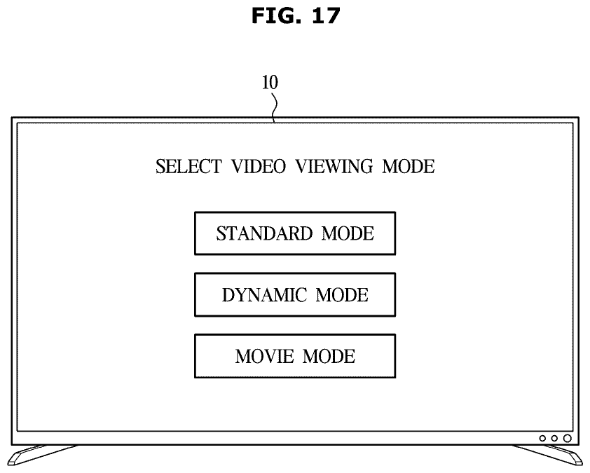

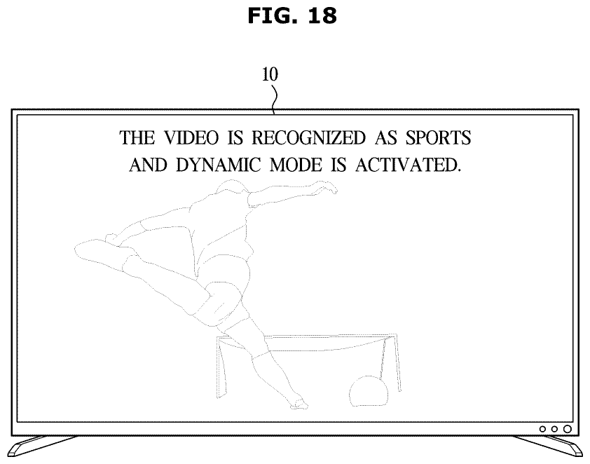

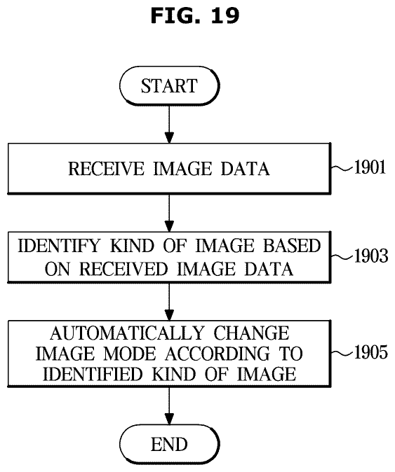

FIG. 17 is a view for describing selecting an image mode according to an embodiment, FIG. 18 is a view for describing automatically changing an image mode according to an embodiment, and FIG. 19 is a flowchart illustrating a process of automatically changing an image mode according to an embodiment.

As described above, the display apparatus 10 may further include an input device that receives a user input. A user may input a user command to the input device through a separate controller provided in the display apparatus 10 or an external device such as a remote controller.

The at least one processor 91 may change an image mode based on the user input received through the input device.

That is, as shown in FIG. 17, a user interface (UI) that enables a user to select an image mode may be provided for the user, and according to an input of a command of selecting an image mode by a user who controls an external device such as a remote controller, the at least one processor 91 may change an image mode based on the input of the command.

As another embodiment, the at least one processor 91 may automatically change an image mode based on received image information.

For example, according to reception of image data (1901), the at least one processor 91 may identify a kind of the image based on the received image data (1903) and change an image mode according to the identified kind of the image (1905).

For example, according to reception of sports image data, as shown in FIG. 18, the at least one processor 91 may identify a kind of the image as a sports image and change an image mode to the dynamic mode accordingly. Also, in the case in which received image data is a movie, the at one processor 91 may identify a kind of the image as a movie and change an image mode to the movie mode.

The at least one processor 91 may perform current value reduction control described above based on the changed image mode to enable a user, etc. to view the image with appropriate colors according to the kind of the image.

Hereinafter, an arrangement of various components included in the display apparatus 10 according to an embodiment will be described.

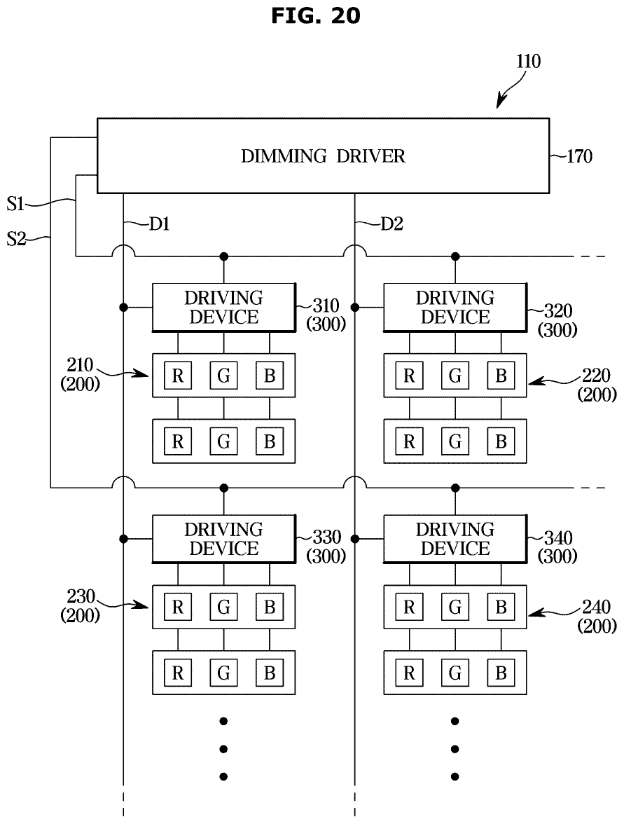

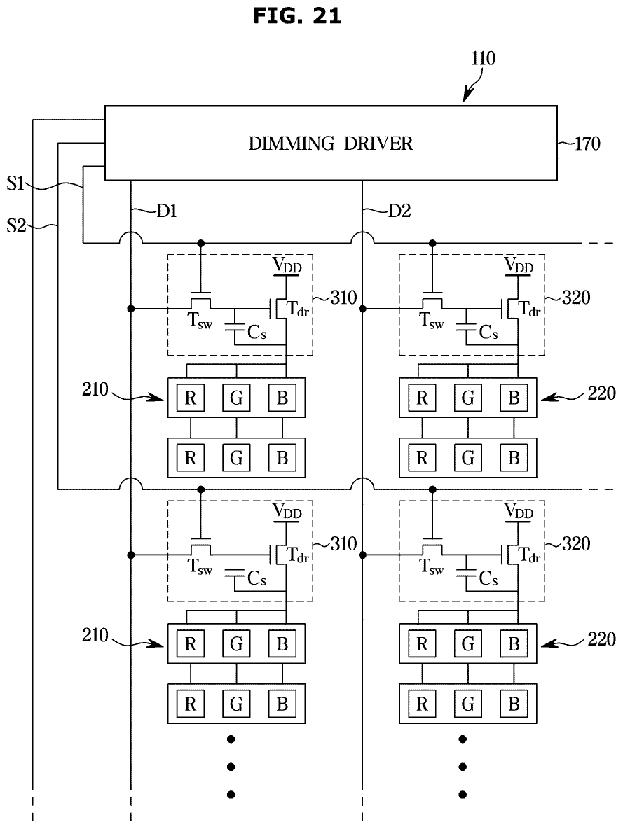

FIGS. 20 and 21 show an arrangement of a dimming driver, a driving device, and a light emitting device, included in a display apparatus according to an embodiment.

Referring to FIGS. 20 and 21, the display apparatus 10 may include the dimming driver 170, the plurality of driving devices 300 (310, 320, 330, 340), and the plurality of light emitting devices 111.

The plurality of light emitting devices 111 may include LEDs and may be divided into the plurality of dimming blocks 200. A plurality of light emitting devices 111 belonging to the same dimming block may form a group.

The plurality of light emitting devices 111 may receive an analog dimming signal from the dimming driver 170 and supply a driving current to the plurality of light emitting devices 111 according to the received analog dimming signal.

As shown in FIG. 20, a plurality of light emitting devices belonging to one dimming block may receive current from the same driving device. For example, a plurality of light emitting devices belonging to a first dimming block 210 may receive driving current from a first driving device 310. A plurality of light emitting devices belonging to a second dimming block 220 may receive driving current from a second driving device 320. A plurality of light emitting devices belonging to a third dimming block 230 may receive driving current from a third driving device 330. A plurality of light emitting devices belonging to a fourth dimming block 240 may receive driving current from a fourth driving device 340. In the same way, a plurality of light emitting devices belonging to a n-th dimming block may receive driving current from a n-th driving device.

Therefore, a plurality of light emitting devices belonging to one dimming block may receive driving current having the same magnitude. Also, a plurality of light emitting devices belonging to one dimming block may emit light having the same intensity.

Also, according to the disclosure, the plurality of light emitting devices 111 belonging to one dimming block 200 may include the red LED 190R, the green LED 190G, and the blue LED 190B, and in this case, LEDs having the same color may receive current from a driving device along the same current supply line.

That is, each of the plurality of driving devices 300 may include a plurality of current supply lines for supplying driving current, and the current supply lines may be arranged to supply driving current to LEDs having the same color.

That is, a current supply line extending from a driving device may be connected only to red LEDs, green LEDs, or blue LEDs, as shown in FIG. 20.

While the driving devices 300 are input-activated by the dimming driver 170, the driving devices 300 may receive an analog dimming signal from the dimming driver 170 and store the received analog dimming signal. Also, while the driving devices 300 are input-deactivated, the plurality of driving devices 300 may supply driving current corresponding to the stored analog dimming signal to the plurality of light emitting devices 111.

A plurality of scan lines S1 and S2 for providing a scan signal from the dimming driver 170 to the plurality of driving devices 300 and a plurality of data lines D1 and D2 for providing an analog dimming signal from the dimming driver 170 to the plurality of driving devices 300 may be provided.

The plurality of dimming blocks 200 may be arranged in a plurality of rows and a plurality of columns. Driving devices that supply driving current to light emitting devices of dimming blocks belonging to the same row may share the same scan line. For example, the first driving device 310 and the second driving device 320 may share a first scan line S1, and the third driving device 330 and the fourth driving device 340 may share a second scan line S2.

Also, driving devices that supply driving current to light emitting devices of dimming blocks belonging to the same column may share the same data line. For example, the first driving device 310 and the third driving device 330 may share a first data line D1, and the second driving device 320 and the fourth driving device 340 may share a second data line D2.

The plurality of driving devices 300 may be input-activated by a scan signal from the dimming driver 170 and receive an analog dimming signal from the dimming driver 170.

For example, while the dimming driver 170 outputs a scan signal through the first scan line S1, the first driving device 310 and the second driving device 320 may receive an analog dimming signal through the first data line DI and the second data line D2. The third driving device 330 and the fourth driving device 340 may receive no analog dimming signal.

Also, while the dimming driver 170 outputs a scan signal through the second scan line S2, the third driving device 330 and the fourth driving device 340 may receive an analog dimming signal through the first data line D1 and the second data line D2. The first driving device 310 and the second driving device 320 may receive no analog dimming signal.

According to reception of an analog dimming signal, the plurality of driving devices 300 may store the received analog dimming signal and supply driving current to a plurality of light emitting devices according to the stored analog dimming signal.

For example, while the dimming driver 170 outputs a scan signal through the first scan line S1, the third driving device 330 and the fourth driving device 340 may supply driving current to a plurality of light emitting devices included in the third dimming block 230 and the fourth dimming block 240.

Also, while the dimming driver 170 outputs a scan signal through the second scan line S2, the first driving device 310 and the second driving device 320 may supply driving current to a plurality of light emitting devices included in the first dimming block 210 and the second dimming block 220.

By such driving based on the active-matrix method, the plurality of driving devices 300 may receive an analog dimming signal sequentially from the dimming driver 170, and, even while the plurality of driving devices 300 are input-deactivated by receiving no analog dimming signal from the dimming driver 170, the plurality of driving devices 300 may supply driving current to the plurality of light emitting devices 111.

By the driving based on the active-matrix method, the number of pins of the dimming driver 170 for providing an analog dimming signal to the plurality of dimming blocks 200 may be reduced. Also, the number of signal lines for providing an analog dimming signal from the dimming driver 170 to the plurality of dimming blocks 200 may be reduced. Therefore, the number of dimming blocks may increase regardless of the number of the pins of the dimming driver 170.

The plurality of driving devices 300 may include various topology circuits to implement driving based on the active-matrix method.

For example, as shown in FIG. 11, each of the plurality of driving devices 300 may include a one capacitor two transistor (1C2T) topology circuit.

Each of the plurality of driving devices 300 may include a driving transistor T_{dr}, a switching transistor T_{sw}, and a storage capacitor Cₛ.

The driving transistor T_{dr} may include an input terminal, an output terminal, and a control terminal. The input terminal of the driving transistor T_{dr} may be connected to a power source V_{dd} and the output terminal of the driving transistor T_{dr} may be connected to a plurality of light emitting devices. The driving transistor T_{dr} may supply driving current to the plurality of light emitting devices according to a voltage of the control terminal.

The storage capacitor Cₛ may be provided between the output terminal and the control terminal of the driving transistor T_{dr}. The storage capacitor Cₛ may store input charges and output a constant voltage. The driving transistor T_{dr} may supply driving current to the plurality of light emitting devices according to a voltage output from the storage capacitor Cₛ.

The switching transistor T_{sw} may also include an input terminal, an output terminal, and a control terminal. The input terminal of the switching transistor T_{sw} may be connected to the data lines D1 and D2 and the output terminal of the switching transistor T_{sw} may be connected to the control terminal of the driving transistor T_{dr}. The control terminal of the switching transistor T_{sw} may be connected to the scan lines S1 and S2.

The switching transistor T_{sw} may be turned on by a scan signal from the scan line S1 or S2 and transfer an analog dimming signal from the data line D1 or D2 to the storage capacitor Cₛ and the driving transistor T_{dr}. The analog dimming signal from the data line D1 or D2 may be input to the control terminal of the driving transistor T_{dr}, and the driving transistor T_{dr} may supply driving current corresponding to the analog dimming signal to the plurality of light emitting devices. The storage capacitor Cₛ may store charges by the analog dimming signal and output a voltage corresponding to the analog dimming signal.

Thereafter, although the scan signal is no longer input and the switching transistor T_{sw} is turned off, the storage capacitor Cₛ may continue to output the voltage corresponding to the analog dimming signal and the driving transistor T_{dr} may continue to supply the driving current corresponding to the analog dimming signal to the plurality of light emitting devices.

The circuit shown in FIG. 21 is only an example of the driving device 300 and the disclosure is not limited thereto. For example, the driving device 300 may include a 3T1C topology circuit to which a transistor for correcting a body effect of the driving transistor T_{dr} is added.

The driving device 300 may be provided, for example, as a single chip into which the circuit shown in FIG. 21 is integrated. In other words, the circuit shown in FIG. 21 may be integrated into a single semiconductor chip.

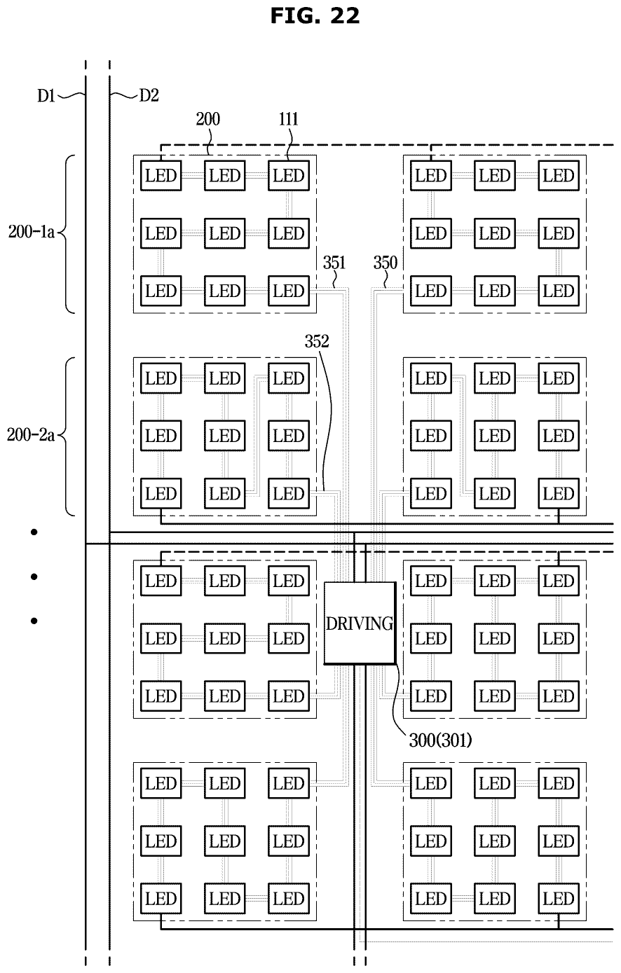

FIG. 22 is a view for describing driving current wires of a driving device of a backlight unit according to an embodiment.

The plurality of driving devices 300 according to an embodiment may be positioned between two neighboring columns in an arrangement of the plurality of dimming blocks 200, as shown in FIG. 22, and supply driving current to at least one of a plurality of dimming blocks 200 included in the neighboring columns through a plurality of driving current wires 350.

In this case, each of the plurality of driving current wires 350 may be connected to two dimming blocks 200 arranged in neighboring rows.

For example, as shown in FIG. 22, a driving current wire 350 of a first driving device 301 may include a first connecting wire 351 connected to a first row 200-1a in the arrangement of the dimming blocks 200, and a second connecting wire 352 connected to a second row 200-2a in the arrangement of the dimming blocks 200, and the driving current wire 350 may be connected to two dimming blocks 200 respectively arranged in the two neighboring rows 200-1a and 200-2a. That is, each of the plurality of driving devices 300 may supply driving current to a plurality of light emitting devices 111 included in at least two dimming blocks 200.

In this case, as described above, a driving current wire extending from a driving device may be connected only to LEDs having the same color to supply current to the LEDs. That is, in an example of the driving current wire 350 of the first driving device 301, driving current wires of three lines may start from the first driving device 301 and be respectively connected only to LEDs having the same colors included in the respective dimming blocks 200. That is, a first line among the three lines of the driving current wire 350 of the first driving device 301 may be connected to a plurality of red LEDs, a second line may be connected to a plurality of green LEDs, and a third line may be connected to a plurality of blue LEDs.

Hereinafter, a structure of a substrate and a chassis included in the display apparatus 10 will be described.

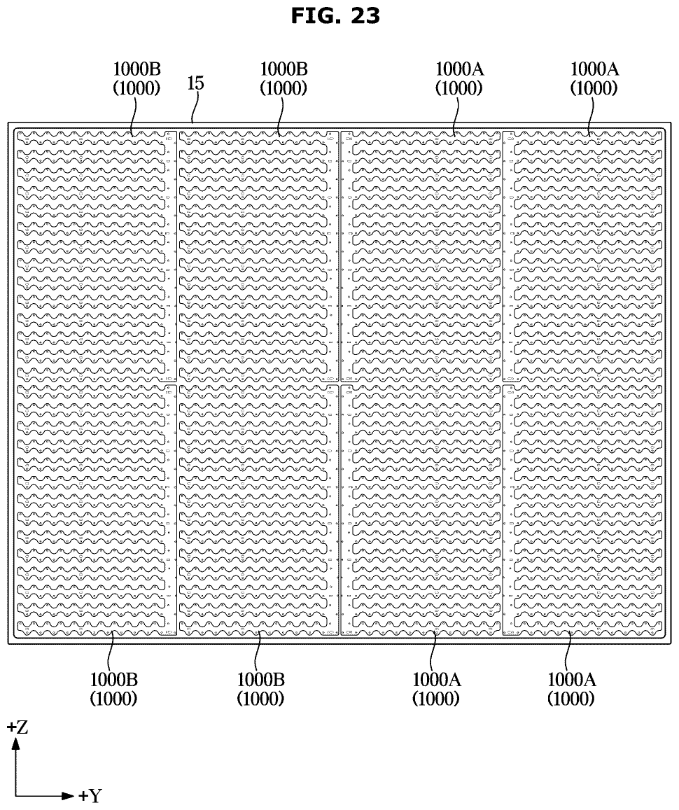

FIG. 23 shows a substrate and a bottom chassis of a display apparatus according to an embodiment.

The backlight unit 100 may include a light source device 1000. The light source device 1000 may generate light and emit the light. The light source device 1000 may emit monochromatic light or white light. Also, in an embodiment of the disclosure, the light source device 1000 may emit light having a plurality of colors.

The light source device 1000 may include a plurality of light sources 1100 that irradiate light and a substrate 1200 on which the plurality of light sources 1100 are mounted.

A plurality of light source devices 1000 may be arranged in a front direction (+X direction) of the bottom chassis 15. For example, the plurality of light source devices 1000 may be mounted on the bottom chassis 15. That is, the plurality of light source devices 1000 may be fixed to the bottom chassis 15 and supported by the bottom chassis 15.

For example, the plurality of light source devices 1000 may be formed in shapes corresponding to each other. In other words, the plurality of light source devices 1000 may have substantially the same structure.

For example, as shown in FIG. 23, a light source device 1000A positioned on a right side (+Y direction) of the display apparatus 10 among the plurality of light source devices 1000 and a light source device 1000B positioned on a left side (−Y direction) of the display apparatus 10 among the plurality of light source devices 1000 may be opposite to each other in vertical and horizontal directions (that is, the light source device 1000A and the light source device 1000B are positioned in a state of being rotated by 180 degrees with respect to each other on a X axis). According to this arrangement, the plurality of light source devices 1000 may be arranged to be bilaterally symmetrical to each other with respect to a horizontal center of the display apparatus 10, and brightness of both sides of the display apparatus 10 from the horizontal center of the display apparatus 10 may be uniform.

As such, because the plurality of light source devices 1000 are designed to have substantially the same shape, waste of parts may be prevented and efficiency of a manufacturing process may be improved, resulting in a reduction of manufacturing cost or manufacturing expense.

However, the disclosure is not limited thereto, and at least a part of the plurality of light source devices 1000 may have a different shape.

FIG. 23 shows an example in which the display apparatus 10 includes 8 light source devices 1000. However, the number of the light source devices 1000 included in the display apparatus 10 is not limited to that shown in FIG. 5. For example, the light source devices 1000 included in the display apparatus 10 may be less or more than the light source devices 1000 shown in FIG. 5. Alternatively, for example, the display apparatus 10 may include a single light source device 1000 integrated into one body.

Hereinafter, a structure of a light source device 1000 among the plurality of light source devices 1000 will be described in detail. According to an embodiment, the structure of the light source device 1000 which will be described below may be applied to each of the plurality of light source devices 1000.

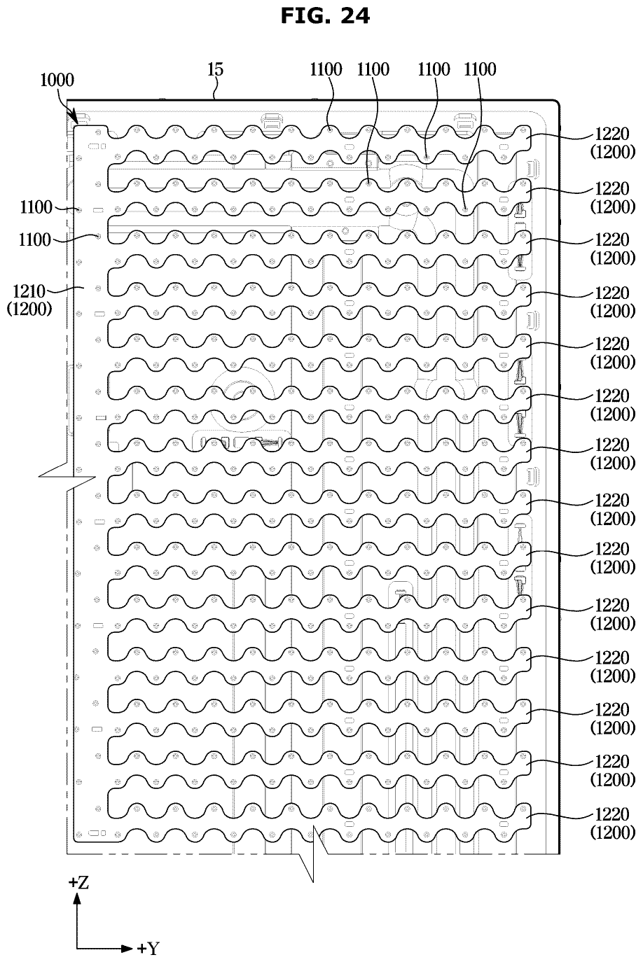

FIG. 24 is an enlarged view of a portion of a substrate and a bottom chassis of a display apparatus according to an embodiment.

Referring to FIG. 24, the light source device 1000 of the display apparatus 10 according to an embodiment of the disclosure may include a plurality of substrate bars 1220.

Each substrate bar 1220 may be a component forming at least a part of the substrate 1200 and include a printed circuit board extending in one direction.

At least a part of the plurality of light sources 1100 may be mounted on the plurality of substrate bars 1220. At least a part of the plurality of light sources 1100 may be mounted on front surfaces of the plurality of substrate bars 1220. Here, the front surfaces of the plurality of substrate bars 1220 may be one surfaces of the plurality of substrate bars 1220 toward the liquid crystal panel 20.

The plurality of substrate bars 1220 may be configured as printed circuit boards on which the light sources 1100 are mounted.

The plurality of substrate bars 1220 may be spaced apart from each other. The plurality of substrate bars 1220 may be spaced apart from each other in the first direction Z. For example, the first direction Z in which the plurality of substrate bars 1220 are spaced apart from each other may be substantially parallel to a vertical direction (that is, an up-down direction) of the display apparatus 10. The plurality of substrate bars 1220 may be arranged in parallel to each other at positions spaced apart from each other.

Each of the plurality of substrate bars 1220 may have a bar shape. Each of the plurality of substrate bars 1220 may have a width in the first direction Z and extend in a second direction Y that is different from the first direction Z. That is, each of the plurality of substrate bars 1220 may have a shape of which a length in the second direction Y is longer than the width in the first direction Z.

For example, a width direction of each of the plurality of substrate bars 1220 may be substantially parallel to the vertical direction (that is, the up-down direction) of the display apparatus 10. For example, a direction in which each of the plurality of substrate bars 1220 extends may be substantially parallel to a horizontal direction (that is, a left-right direction) of the display apparatus 10.

For example, the direction in which each of the plurality of substrate bars 1220 extends may be parallel to a direction of a long side of the display apparatus 10. For example, the width direction of each of the plurality of substrate bars 1220 may be parallel to a direction of a short side of the display apparatus 10.

A direction in which the plurality of substrate bars 1220 are arranged in such a way as to be spaced apart from each other may be parallel to the width direction. In other words, the plurality of substrate bars 1220 may be spaced apart from each other in the first direction Z which is the width direction.

Each of the plurality of substrate bars 1220 may extend in a direction that is different from the direction in which the plurality of substrate bars 1220 are spaced apart from each other. Each of the plurality of substrate bars 1220 may extend in a direction (Y direction) that is orthogonal to the direction (Z direction) in which the plurality of substrate bars 1220 are spaced apart from each other. That is, the second direction may be orthogonal to the first direction.

In contrast, the direction in which the plurality of substrate bars 1220 are arranged in such a way as to be spaced apart from each other and the direction in which each of the plurality of substrate bars 1220 extends may form a preset angle with respect to each other, wherein the preset angle may not be exactly 90 degrees.

For example, the plurality of substrate bars 1220 may be arranged in such a way as to be spaced apart from each other at a uniform distance in the first direction Z. In other words, distances in first direction (Z direction) between a pair of neighboring substrate bars 1220 among the plurality of substrate bars 1220 may be the same. Therefore, brightness uniformity of the display apparatus 10 may be improved.

For example, the plurality of substrate bars 1220 may have shapes corresponding to each other. For example, widths in first direction (Z direction) of the plurality of substrate bars 1220 may correspond to each other. For example, lengths by which the plurality of substrate bars 1220 extend in the second direction (Y direction) may correspond to each other. For example, the plurality of substrate bars 1220 may be formed with sizes corresponding to each other.

For example, each of the plurality of substrate bars 1220 may be mounted on the bottom chassis 15. Because each of the plurality of substrate bars 1220 is mounted on the bottom chassis 15 and maintained at a fixed location, the plurality of light sources 1100 mounted on the plurality of substrate bars 1220 may be stably arranged at designed locations.

A reflective sheet 120 may be attached on a front surface of each of the plurality of substrate bars 1220.

The light source device 1000 of the display apparatus 10 may include a substrate body 1210. The substrate body 1210 may be a component forming a part of the substrate 1200 described above and including a printed circuit board.

The plurality of substrate bars 1220 may be connected to the substrate body 1210. The plurality of substrate bars 1220 may be supported by the substrate body 1210. For example, the plurality of substrate bars 1220 may be connected to one side of the substrate body 1210.

The plurality of substrate bars 1220 may extend from the substrate body 1210. For example, each of the plurality of substrate bars 1220 may extend from the substrate body 1210 in the second direction (Y direction). For example, each of the plurality of substrate bars 1220 may extend from one side of the substrate body 1210 in the second direction (Y direction).

For example, the substrate body 1210 may extend along the first direction (Z direction). For example, a length in first direction (Z direction) of the substrate body 1210 may be longer than a width in second direction (Y direction) of the substrate body 1210. In this case, because the substrate body 1210 extends along a direction in which the plurality of substrate bars 1220 are arranged, the substrate body 1210 may have a structure in which a greater number of substrate bars 1220 are connected to the substrate body 1210. Also, in this case, because the plurality of substrate bars 1220 extend from one side of the substrate body 1210 in the second direction (Y direction) which is a width direction (that is, a direction in which the substrate body 1210 has a relatively short length) of the substrate body 1210, each of the plurality of substrate bars 1220 may extend with a long length.

For example, the substrate body 1210 may be mounted on the bottom chassis 15. Because the substrate body 1210 is mounted on the bottom chassis 15 and maintained at a fixed location, the plurality of light sources 1100 mounted on the substrate body 1210 may be stably arranged at designed locations. Also, because the substrate body 1210 is mounted on the bottom chassis 15, the plurality of substrate bars 1220 connected to the substrate body 1210 may be more stably supported by the substrate body 1210.

For example, a part of the plurality of light sources 1100 may be mounted on the substrate body 1210. The part of the plurality of light sources 1100 may be mounted on a front surface of the substrate body 1210. The front surface of the substrate body 1210 may be one surface of the substrate body 1210 in a direction in which the substrate body 1210 faces the liquid crystal panel 20.

The substrate body 1210 may be configured as a printed circuit board on which the light sources 1100 are mounted.

The reflective sheet 120 may be attached on the front surface of the substrate body 1210. For example, the reflective sheet 120 may be attached on the front surfaces of the substrate body 1210 and the plurality of substrate bars 1220. In this case, uniformity of brightness by light reflected by the reflective sheet 120 may be improved, and a process of attaching the reflective sheet 120 on the front surfaces of the substrate body 1210 and the plurality of substrate bars 1220 may be simplified. However, the disclosure is not limited thereto, and a plurality of reflective sheets 120 that are distinguished from each other may be attached on the front surfaces of the substrate body 1210 and the plurality of substrate bars 1220.

For example, the substrate body 1210 and the plurality of substrate bars 1220 may be integrated into one body. In other words, the substrate body 1210 and the plurality of substrate bars 1220 may be connected to each other to configure one substrate 1200. The substrate 1200 may be configured as a printed circuit board including the substrate body 1210 and the plurality of substrate bars 1220. However, unlike this, the substrate body 1210 and the plurality of substrate bars 1220 may be provided as separate components and connected to each other through an assembly process.

The structure of the light source device 1000 including the substrate body 1210, the substrate bars 1220, etc., as described above with reference to FIG. 6, is only an example, and a concept of the disclosure is not limited thereto.

In FIG. 24, an embodiment in which each of the plurality of substrate bars 1220 extends in a right direction (+Y direction) from the substrate body 1210 is shown. However, the disclosure is not limited thereto, and, for example, the plurality of substrate bars 1220 may extend in a left direction (−Y direction) from the substrate body 1210.

Also, FIG. 24 shows an embodiment in which the substrate body 1210 extends in the vertical direction (Z direction) of the display apparatus 10. However, the disclosure is not limited thereto, and for example, the substrate body 1210 may extend in the horizontal direction (Y direction).

Also, FIG. 24 shows an embodiment in which each of the plurality of substrate bars 1220 extends from one side in horizontal direction (Y direction) of the substrate body 1210. However, the disclosure is not limited thereto, and for example, the plurality of substrate bars 1220 may extend in the vertical direction (Z direction) from one side in vertical direction (Z direction) of the substrate body 1210. In this case, the plurality of substrate bars 1220 may be arranged in such a way as to be spaced apart from each other in the horizontal direction (Y direction).

Also, unlike the above description, the first direction which is the width direction of the plurality of substrate bars 1220, the first direction in which the plurality of substrate bars 1220 are arranged to be spaced apart from each other, the first direction in which the substrate body 1210 extends, or the second direction in which each of the plurality of substrate bars 1220 extends may not be parallel to any of the vertical direction (Z direction) or horizontal direction (Y direction) of the display apparatus 10.

A display apparatus according to an embodiment may include: a liquid crystal panel; a backlight unit configured to provide light to the liquid crystal panel; and at least one processor configured to control the liquid crystal panel and the backlight unit, wherein the backlight unit may include: a substrate; a plurality of dimming blocks arranged in a plurality of rows and a plurality of columns on the substrate, each of the plurality of dimming blocks including a plurality of light emitting devices; and a plurality of driving devices configured to drive the plurality of dimming blocks, each of the plurality of light emitting devices may include a red light emitting diode (LED), a green LED, and a blue LED, and the at least one processor may be configured to control the plurality of driving devices to adjust a current value that is supplied to at least one of the red LED, the green LED, or the blue LED according to an image mode.

According to the disclosure, by adjusting a current value that is supplied to at least one of the red LED, the green LED, or the blue LED included in the backlight unit according to an image mode, power consumption may be reduced.

Also, by including the red LED, the green LED, and the blue LED as light sources of the backlight unit, higher color purity and a higher contrast ratio than in local dimming using single light may be achieved.

The at least one processor may be configured to control the plurality of riving devices to reduce the current value that is supplied to the at least one of the red LED, the green LED, or the blue LED according to a change of the image mode.

The at least one processor may be configured to control the plurality of driving devices to supply current corresponding to the reduced current value to the plurality of dimming blocks based on received image information.

The at least one processor may be configured to reduce a current value that is supplied to the green LED and the blue LED through PAM control and supply current corresponding to the reduced current value to the plurality of dimming blocks.

The at least one processor may be configured to control the plurality of driving devices to supply current corresponding to the image information to each of the plurality of dimming blocks based on the image information.

The at least one processor may be configured to supply the current corresponding to the image information to each of the plurality of dimming blocks through PWM control.

The display apparatus may further include an input device configured to receive a user input, wherein the image mode may change based on a user input received through the input device.

The at least one processor may be configured to automatically change the image mode based on the image information.

Each of the plurality of driving devices may be configured to supply driving current to a plurality of light emitting devices included in at least two dimming blocks.

The display apparatus may further include a plurality of current supply lines through which each of the plurality of driving devices supplies driving current, wherein the plurality of current supply lines may be arranged to supply driving current to LEDs having the same color.

The plurality of driving devices may be positioned on an upper surface or a lower surface of the substrate.

Each of the plurality of dimming blocks may include a preset number of light emitting devices.

A display apparatus according to an embodiment may include: a liquid crystal panel; a backlight unit configured to provide light to the liquid crystal panel; an input device configured to receive a user input; and at least one processor configured to control the liquid crystal panel and the backlight unit, wherein the backlight unit may include: a substrate; a plurality of dimming blocks arranged in a plurality of rows and a plurality of columns on the substrate, each of the plurality of dimming blocks including a plurality of light emitting devices; and a plurality of driving devices configured to drive the plurality of dimming blocks, each of the plurality of light emitting devices may include a red light emitting diode (LED), a green LED, and a blue LED, and the at least one processor may be configured to control the plurality of driving devices to reduce a current value that is supplied to at least one of the red LED, the green LED, or the blue LED based on a change of an image mode according to a user's input of selecting another image mode, received through the input device.

The at least one processor may be configured to control the plurality of driving devices to supply current corresponding to the reduced current value to the plurality of dimming blocks based on received image information.

The at least one processor may be configured to control the plurality of driving devices to supply current corresponding to the image information to each of the plurality of dimming blocks based on the image information.

A display apparatus according to an embodiment may include: a liquid crystal panel; a backlight unit configured to provide light to the liquid crystal panel; and at least one processor configured to control the liquid crystal panel and the backlight unit, wherein the backlight unit may include: a substrate; a plurality of dimming blocks arranged in a plurality of rows and a plurality of columns on the substrate, each of the plurality of dimming blocks including a plurality of light emitting devices; and a plurality of driving devices configured to drive the plurality of dimming blocks, each of the plurality of light emitting devices may include a red light emitting diode (LED), a green LED, and a blue LED, and the at least one processor may be configured to change an image mode based on received image information and control the plurality of driving devices to reduce a current value that is supplied to at least one of the red LED, the green LED, or the blue LED based on the change of the image mode.

The at least one processor may be configured to control the plurality of driving devices to supply current corresponding to the reduced current value to the plurality of dimming blocks based on the image information.

The at least one processor may be configured to control the plurality of driving devices to supply current corresponding to the image information to each of the plurality of dimming blocks based on the image information.

According to the disclosure, by adjusting a current value that is supplied to at least one of the red LED, the green LED, or the blue LED included in the backlight unit according to an image mode, power consumption may be reduced.

Also, by including the red LED, the green LED, and the blue LED as light sources of the backlight unit, higher color purity and a higher contrast ratio than in local dimming using single light may be achieved.

The disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

Embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

What is claimed is:

1. A display apparatus comprising:
a liquid crystal panel;
memory storing instructions;
a backlight unit configured to provide light to the liquid crystal panel; and
at least one processor configured to control the liquid crystal panel and the backlight unit,
wherein the backlight unit comprises:
a substrate;
a plurality of dimming blocks arranged in a plurality of rows and a plurality of columns on the substrate, each dimming block of the plurality of dimming blocks comprising a plurality of light emitting devices; and
a plurality of driving devices configured to drive the plurality of dimming blocks,
wherein each light emitting device of the plurality of light emitting devices comprises a red light emitting diode (LED), a green LED, and a blue LED, and
wherein the instructions, when executed by the at least one processor, cause the display apparatus to control the plurality of driving devices to adjust a current value that is supplied to at least one of the red LED, the green LED, or the blue LED, according to an image mode.

2. The display apparatus of claim 1, wherein the instructions, when executed by the at least one processor, cause the display apparatus to control the plurality of driving devices to reduce the current value that is supplied to the at least one of the red LED, the green LED, or the blue LED according to the image mode.

3. The display apparatus of claim 2, wherein the instructions, when executed by the at least one processor, cause the display apparatus to control the plurality of driving devices to supply current corresponding to the reduced current value to the plurality of dimming blocks based on obtained image information.

4. The display apparatus of claim 3, wherein the instructions, when executed by the at least one processor, cause the display apparatus to reduce the current value that is supplied to the green LED and the blue LED through pulse amplitude modulation (PAM) control and supply the current corresponding to the reduced current value to the plurality of dimming blocks.

5. The display apparatus of claim 3, wherein the instructions, when executed by the at least one processor, cause the display apparatus to control the plurality of driving devices to supply the current corresponding to the image information to each dimming block of the plurality of dimming blocks based on the image information.

6. The display apparatus of claim 5, wherein the instructions, when executed by the at least one processor, cause the display apparatus to supply the current corresponding to the image information to each dimming block of the plurality of dimming blocks through pulse width modulation (PWM) control.

7. The display apparatus of claim 1, further comprising an input device configured to obtain a user input,
wherein the instructions, when executed by the at least one processor, cause the display apparatus to change the image mode based on the user input obtained through the input device.

8. The display apparatus of claim 1, wherein the instructions, when executed by the at least one processor, cause the display apparatus to automatically change the image mode based on image information.

9. The display apparatus of claim 1, wherein each driving device of the plurality of driving devices is configured to supply driving current to the plurality of light emitting devices of at least two dimming blocks.

10. The display apparatus of claim 9, further comprising:
a plurality of current supply lines through which each driving device of the plurality of driving devices supplies driving current,
wherein the plurality of current supply lines are configured to supply driving current to LEDs having a same color.

11. The display apparatus of claim 1, wherein the plurality of driving devices are provided on an upper surface of the substrate or a lower surface of the substrate.

12. The display apparatus of claim 1, wherein each dimming block of the plurality of dimming blocks comprises a preset number of light emitting devices.

13. A display apparatus comprising:
a liquid crystal panel;
memory storing instructions;
a backlight unit configured to provide light to the liquid crystal panel;
an input device configured to obtain a user input; and
at least one processor configured to control the liquid crystal panel and the backlight,
wherein the backlight unit comprises:
a substrate;
a plurality of dimming blocks arranged in a plurality of rows and a plurality of columns on the substrate, each dimming block of the plurality of dimming blocks comprising a plurality of light emitting devices; and
a plurality of driving devices configured to drive the plurality of dimming blocks,
wherein each light emitting device of the plurality of light emitting devices comprises a red light emitting diode (LED), a green LED, and a blue LED, and
wherein the instructions, when executed by the at least one processor, cause the display apparatus to control the plurality of driving devices to reduce a current value that is supplied to at least one of the red LED, the green LED, or the blue LED based on a change of an image mode according to a user's input of selecting another image mode, obtained through the input device.

14. The display apparatus of claim 13, wherein the instructions, when executed by the at least one processor, cause the display apparatus to control the plurality of driving devices to supply current corresponding to the reduced current value to the plurality of dimming blocks based on obtained image information.

15. The display apparatus of claim 14, wherein the instructions, when executed by the at least one processor. cause the display apparatus to control the plurality of driving devices to supply the current corresponding to the image information to each dimming block of the plurality of dimming blocks based on the image information.
